(19) United States
(12) Patent Application Publication
(10) Pub. No.: US 2025/0290688 A1
(43) Pub. Date: Sep. 18, 2025

(54) REFRIGERATOR

(71) Applicant: LG ELECTRONICS INC., Seoul (KR)

(72) Inventors: Sun Kook JI, Seoul (KR); Sung Hyun YUN, Seoul (KR)

(21) Appl. No.: 19/051,422

(22) Filed: Feb. 12, 2025

(30) Foreign Application Priority Data
Mar. 15, 2024 (KR) 10-2024-0036548

(51) Int. Cl. F25D 27/00; F25D 23/02; F25D 23/04

(52) U.S. Cl. CPC F25D 27/00; F25D 23/028; F25D 23/04; F25D 2323/023

(57) ABSTRACT

A refrigerator includes a light-source assembly that irradiates light to a basket and at the same time, plays a role in fixing the basket to a door. Thus, the fixing of the basket to the door and the illumination effect toward the basket are achieved using one structure rather than as separate structures.

### CROSS-REFERENCE TO RELATED APPLICATION

This application claims priority to and the benefit of Korean Patent Application No. 10-2024-0036548, filed on Mar. 15, 2024, the disclosure of which is incorporated herein by reference in its entirety.

### BACKGROUND

### Field

The present disclosure relates to a refrigerator.

### Description of Related Art

A refrigerator is an electrical appliance that supplies cold air generated by circulating refrigerant to a storage chamber to store therein various types of storage targets in the storage chamber for a long period of time.

Recently, a user's demand to improve an outer appearance of the refrigerator and consider various user tastes are increasing.

In particular, a door constituting a front surface of the refrigerator determines the outer appearance of the refrigerator. Thus, the user' demand may be satisfied using the door having various materials, colors, and design patterns.

In general, it is difficult for the user to identify a type or a storage status of food stored in the refrigerator without opening the door.

In order to identify the type or the storage status of food, the number of times the user opens the door or a time duration for which the door is in the open state increases, thereby causing unnecessary leakage of cold air inside the storage chamber.

Accordingly, a portion of the door may be designed to be translucent or transparent, such that the type or the storage status of food stored in the storage chamber may be identified by the user without opening the refrigerator door.

However, even when the storage status inside the storage chamber can be identified without opening the door, it may be difficult to identify the storage status inside the storage chamber in a dark environment.

Furthermore, when the storage status inside the storage chamber can be identified by the user without opening the door, there may be a situation where the user may see through the inside of the storage chamber even when the refrigerator is not in use. Thus, a design of the inside of the storage chamber or an inside of the door may need to be improved.

In addition, since the users recently tend to consider the refrigerator as a design element, there is an increasing demand for a structure that allows not only a basket inside the refrigerator but also the food stored in the basket to contribute to improved aesthetics.

### SUMMARY

A purpose of the present disclosure is to provide a refrigerator that may implement fixation and an illumination effect of the basket with a single structure.

Furthermore, a purpose of the present disclosure is to provide a refrigerator that may reduce an alignment error between a light source module and a light guide member.

Furthermore, a purpose of the present disclosure is to provide a refrigerator that may maintain each of the light source module and the light guide member at a fixed position regardless of whether the basket is removed or not from a door.

Furthermore, a purpose of the present disclosure is to provide a refrigerator that may allow a defective light-source assembly to be easily repaired or replaced.

Furthermore, a purpose of the present disclosure is to provide a refrigerator that may implement various types of illumination effects simply by replacing a light-source assembly.

Furthermore, a purpose of the present disclosure is to provide a refrigerator that may implement an illumination effect on an entirety of a surface of the basket that is recognized by the user when an auxiliary door and a main door are opened.

Furthermore, a purpose of the present disclosure is to provide a refrigerator that may implement an illumination effect of the basket according to turn on or off of a light source module even when the door is closed.

Furthermore, a purpose of the present disclosure is to provide a refrigerator that may allow the user to easily check the status of food stored in the basket even when the door is closed, thereby reducing a time duration for which the door is in the open state.

Furthermore, a purpose of the present disclosure is to provide a refrigerator that may implement an excellent decoration effect under illumination in various schemes in various situations.

A refrigerator according to one embodiment of the present disclosure for achieving the purposes as described above includes a cabinet having one or more storage chambers defined therein, a door that opens and closes the storage chamber, a plurality of light-source assemblies positioned at the door, and a basket mounted on the door.

In this case, each of the light-source assemblies includes a light source module, a lightguide member that guides light emitted from the light source module to the basket, and a casing that protrudes toward the basket and supporting the basket.

The refrigerator according to the present disclosure may have the light-source assembly that irradiates light to the basket and plays a role in fixing the basket to the door.

Accordingly, the fixing and illumination effects of the basket may be implemented simultaneously using a single structure rather than as separate structures.

Furthermore, in the refrigerator according to the present disclosure, a single light-source assembly may be configured such that a light source module and a lightguide member that guides light irradiated from the light source module are received in a casing.

Accordingly, variation in an amount or a direction of the illumination toward the basket that may occur due to an unintended alignment error between the light source module and the lightguide member may be prevented.

Furthermore, in the refrigerator according to the present disclosure, the positions of the light source module and the lightguide member may be fixed regardless of whether the basket is detached or not from the door, such that variation in an amount or a direction of the illumination toward the basket that may occur due to unintended changes in the positions of the light source module or the lightguide member may be prevented.

Furthermore, in the refrigerator according to the present disclosure, the light-source assembly may be provided as a kind of a light-source assembly kit which may be detachably fastened to the door. Thus, in the event of the defect occurring in the light source module, only the light-source assembly including the light source module requiring repair may be removed therefrom and replaced with a non-defective light source module, so that the repair or replacement of the light source module may be made quick and easy.

Furthermore, in the refrigerator according to the present disclosure, the light-source assembly may be provided as a kind of a light-source assembly kit which may be detachably fastened to the door. Thus, various types of illumination effects, and thus, excellent decoration effects and design differentiation may be implemented by simply exchanging the light-source assemblies of a variety of forms with each other, wherein the light-source assemblies of the variety of forms have different numbers, locations, areas, shapes, etc. of the light source modules included in each of the light-source assemblies.

Furthermore, in the refrigerator according to the present disclosure, the light-source assembly may directly irradiate light onto the basket and thus serve as an illumination member, so that the food stored in the basket may be visible to the outside, thereby enhancing the aesthetics.

Furthermore, the refrigerator according to the present disclosure may freely change the basket in various ways, such as changing the material or the shape of the basket or forming the pattern in a specific area, so that various types of illumination effects may be implemented according to the deformation of the basket acting as the optical member, thereby achieving excellent decoration effects and design differentiation.

Furthermore, the door of the refrigerator according to the present disclosure includes a main door having an opening defined therein and pivotable around the cabinet, and an auxiliary door that may open and close the opening of the main door and may be pivotable around the main door. The basket is mounted on the main door. Thus, when the auxiliary door and the main door are opened, the user may recognize each of the front surface and the back surface of the basket.

Accordingly, the basket may implement the illumination effect along a side surface edge of a base member, and thus may implement the illumination effect on all sides thereof recognized by the user when the auxiliary door and the main door are opened. A design effect under illumination toward the entirety of the basket may be achieved.

Furthermore, in the refrigerator according to the present disclosure, the user can see the inside of the storage chamber through the front surface of the door. The refrigerator includes various types of detection devices. The light source module may be turned on or off based on the signal from the detection device. Thus, the illumination effect toward the basket may be implemented according to the on or off of the light source module even when the door is in the closed states, thereby providing an excellent decoration effect without unnecessary leakage of cold air.

Accordingly, the type and the status of the food stored in the basket may be easily identified by the user even when the refrigerator door is in the closed state. Thus, the status of the food may be easily managed, and the time duration for which the door is in the open state may be reduced, thereby reducing energy consumption.

Furthermore, in the refrigerator according to the present disclosure, a lighting unit may be disposed in the storage chamber or on the door, and the controller may control the on/off of each of the light source module and the lighting unit individually or in an associated manner with each other, based on the signal from the detection device or the remote device, thereby providing excellent decoration effect in various schemes and in various situations.

### BRIEF DESCRIPTION OF DRAWINGS

FIG. 1 and FIG. 2 are front views of a refrigerator with a door being closed in a state in which a user can see through a front surface of the door and in a state in which a user cannot see through a front surface of the door, respectively.

FIG. 3 and FIG. 4 are front views of a refrigerator in a state in which an auxiliary door is open and in a state in which a main door is open, respectively.

FIG. 5 illustrates a first door in a state in which the auxiliary door is open.

FIG. 6 illustrates the first door of an integral type.

FIG. 7 illustrates a main door of the first door.

FIG. 8 is an exploded perspective view of the main door, a light-source assembly, and a basket of the first door.

FIG. 9 illustrates a state in which an electrical wire is connected to each light-source assembly.

FIG. 10 illustrates a recess formed in a door liner, a light-source assembly fastened to the door liner, and a basket fixed to the door liner.

FIG. 11 is an exploded perspective view of the light-source assembly.

FIG. 12 is a rear perspective view of the casing.

FIG. 13 and FIG. 14 are a front perspective view and a rear view of the light-source assembly, respectively.

FIG. 15 is a vertical cross-sectional view of the light-source assembly coupled to the recess.

FIGS. 16 to 18 are cross-sectional views illustrating various embodiments of the light-source assembly that irradiates light to a side surface of the basket.

FIG. 19 illustrates a lower surface of the basket.

FIG. 20 illustrates another embodiment of the basket implemented in a separate form.

FIGS. 21 to 30 are perspective views illustrating various embodiments of the light-source assembly.

FIG. 31 is a block diagram showing flow of a control signal of the refrigerator.

FIG. 32 is a diagram showing a screen implemented in a remote device or a display unit.

FIG. 33 is a front view of a refrigerator according to another embodiment in a state in which one auxiliary door is open.

FIG. 34 is a front view of a refrigerator according to another embodiment in a state in which one main door is open.

FIG. 35 is a side cross-sectional view of a basket assembly, a shelf, and a storage target receiver mounted on the first door and in a first storage chamber according to another embodiment.

FIG. 36 is an exploded perspective view of a second door including a dispenser according to another embodiment.

FIG. 37 is a diagram showing a screen implemented in a remote device or a display unit according to another embodiment.

FIG. 38 is a flowchart according to one embodiment of a scenario for controlling light emission in various types of illumination.

### DETAILED DESCRIPTIONS

Hereinafter, a refrigerator according to some embodiments of the present disclosure will be described.

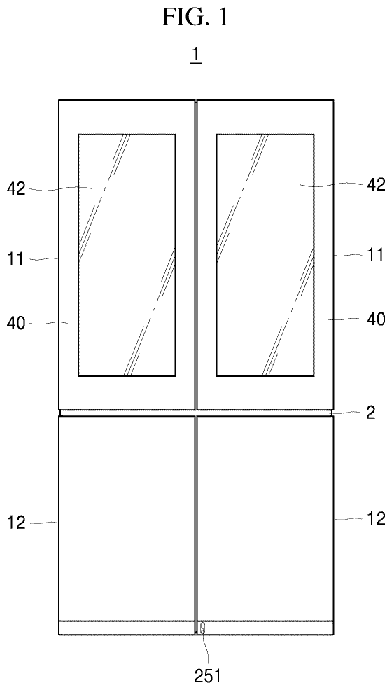

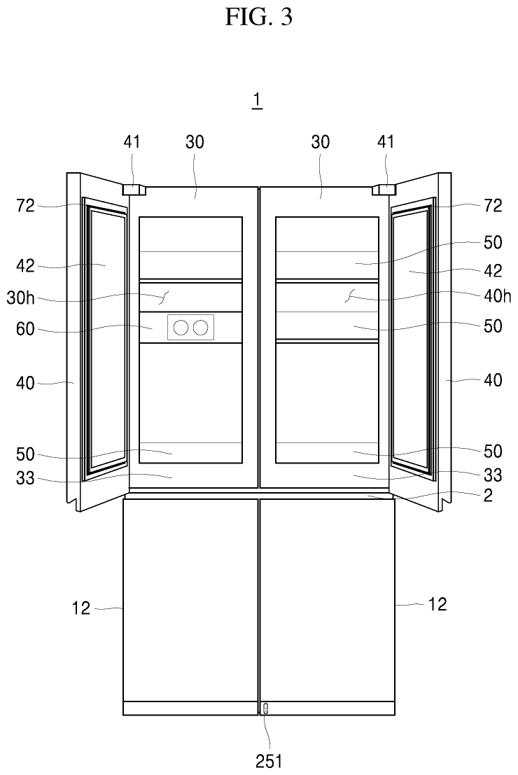

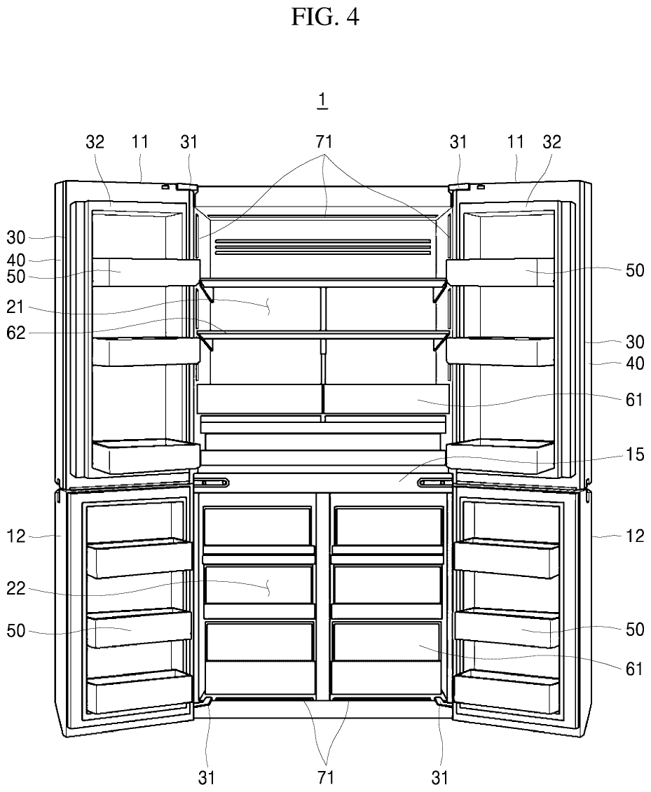

First, with reference to FIG. 1 to FIG. 4, a refrigerator according to an embodiment of the present disclosure and a connection relationship of major components thereof will be described.

A refrigerator 1 may include a cabinet 2 having one or more storage chambers defined therein acting as a storage space of foods, and one or more doors 11 and 12 that may open and close an open front surface of the cabinet 2. The cabinet 2 and the doors 11 and 12 may define an outer appearance of the refrigerator.

The cabinet 2 may include an outer casing constituting an outer surface of the refrigerator 1 and an inner casing constituting an inner surface thereof, and an inner space of the inner casing may be divided into one or more storage spaces.

The cabinet 2 may have one or more storage chambers defined therein which may include, for example, a first storage chamber 21 and a second storage chamber 22 that are arranged in a vertical direction and are removed from each other via a barrier 15.

In one example, the first storage chamber 21 as an upper storage chamber may act as a refrigerating chamber, and the second storage chamber 22 as a lower storage chamber may act as a freezing chamber.

However, the positions of the first storage chamber 21 and the second storage chamber 22 are not limited thereto. In another embodiment, the first storage chamber 21 as an upper storage chamber may act as a freezing chamber, and the second storage chamber 22 as a lower storage chamber may act as a refrigerating chamber. Alternatively, the first storage chamber 21 and the second storage chamber 22 may be arranged in a left-right direction and side by side.

One or more storage target receivers 61 and shelves 62 capable of storing food therein may be disposed in each of the first storage chamber 21 and the second storage chamber 22.

One or more inside-lighting units 71 for illuminating the inside of each of the first storage chamber 21 and the second storage chamber 22 may be disposed in each of the first storage chamber 21 and the second storage chamber 22.

For example, the inside-lighting unit 71 may be disposed at any location such as an upper surface, a lower surface, and a side surface defining each storage chamber.

The first door 11 may be pivotable to open and close an open front surface of the first storage chamber 21. The second door 12 may be pivotable to open and close an open front surface of the second storage chamber 22.

Each of the first door 11 and the second door 12 may be provided as a pair of doors respectively disposed at left-right sides, and may shield each of the first storage chamber 21 and the second storage chamber 22.

However, the present disclosure is not limited thereto, and the first door 11 or the second door 12 may move not in a pivoting manner but in an extend/retract manner. Further, only one door for opening and closing each storage chamber may be provided.

Each of the first door 11 and the second door 12 may be provided with one or more baskets 50. The basket 50 may be constructed so as not to interfere with the storage target receivers 61 provided in the storage chamber in a state in which each of the first door 11 and the second door 12 has been closed.

In one example, at least one of the pair of first doors 11 may be configured to be of a dual door type in which two doors may be individually opened and closed.

For example, the first door 11 of the double door type may include a main door 30 that opens and closes the first storage chamber 21, and an auxiliary door 40 that is disposed in front of the main door 30 so as to pivot relative to the main door 30 to open and close a front surface of the main door 30.

The main door 30 is pivotally mounted at the cabinet 2 via a main hinge 31 to open and close a portion of the first storage chamber 21.

The main door 30 may have an opening 30h defined therein so as to extend through the main door 30 in the front-back direction.

The main door 30 may include an outer plate 33, a door liner 32 coupled to a rear surface of the outer plate 33, and an upper cap decoration 35 and a lower cap decoration 36 that cover an upper end and a lower end of each of the outer plate 33 and the door liner 32, respectively. The outer plate 33, the door liner 32, the upper cap decoration 35 and the lower cap decoration 36 constitute an outer appearance of the main door 30.

The outer plate 33 may be made of a plate-shaped stainless steel material, and may be bent to constitute a front surface and a side edge of the main door 30.

The outer plate 33 may have a portion of the opening 30h defined therein.

The door liner 32 may be injection-molded using a plastic material, and may constitute a rear surface of the main door 30.

The door liner 32 may have a portion of the opening 30h defined therein.

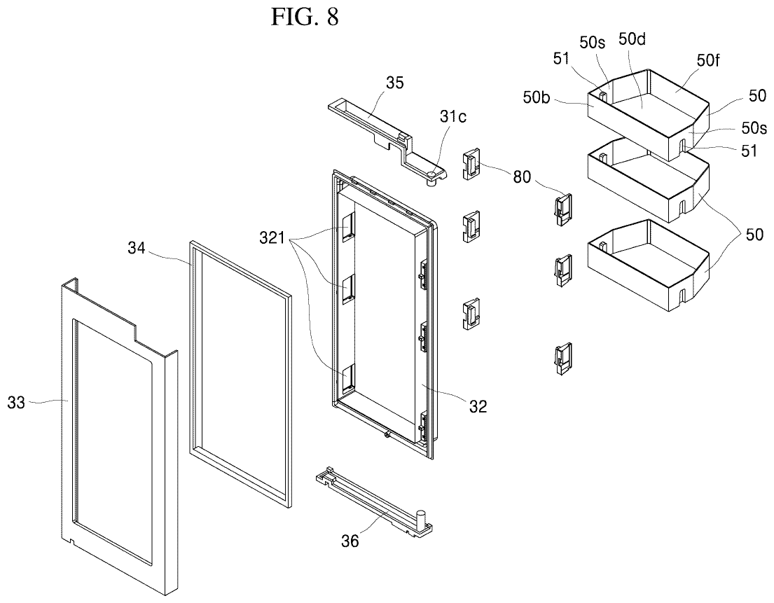

Referring to FIG. 8, a door frame 34 may be additionally disposed between the outer plate 33 and the door liner 32.

The door frame 34 may be injection-molded using a plastic material, and may be formed in a hollow shape so as to surround an outer side surface of the door liner 32. The door frame 34 may be fixed to each of the outer plate 33 and the door liner 32 in a fitting manner.

The user may see the inside of the storage chamber through the opening 30h of the main door 30 formed in this manner, or may take out or store the food out of or in the storage chamber the opening 30h.

One or more baskets 50 may be mounted on the rear surface of the main door 30.

For example, a portion of the basket 50 may be received in a portion of the opening 30h defined in the door liner 32 and extend in a left-right direction of the door liner 32.

Therefore, the basket 50 may be exposed to the outside through the opening 30h of the main door 30.

The user may access the basket 50 through the opening 30h without opening the main door 30.

The opening 30h may be sized so as to occupy a significant portion of the front surface of the main door 30 excluding a perimeter portion of the main door 30.

The main door 30 may be equipped with one or more display units 60.

The display unit 60 may be configured to display an operation status of the refrigerator 1, and may allow the user to manipulate the display unit 60 to operate the refrigerator 1. The user positioned out of the refrigerator 1 may identify various information on the display unit 60 through the auxiliary door 40.

The display unit 60 may be equipped with a display screen for displaying the status information of the refrigerator 1 and various manipulation buttons for setting the operation of the refrigerator 1.

The display unit 60 may be positioned to overlap the basket 50 in the front-back direction of the main door 30.

The auxiliary door 40 may be pivotally mounted to the main door 30 via an auxiliary hinge 41 and may open and close the opening 30h defined in the front surface of the main door 30.

The auxiliary door 40 may include a light-transmissive portion 42 constituting a front surface thereof.

The light-transmissive portion 42 of the auxiliary door 40 may be positioned to overlap the opening 30h of the main door 30 in the front-back direction, and may be formed in a shape and a size corresponding to a shape and a size of the opening 30h of the main door 30.

Therefore, the user may see the inside of the first storage chamber 21 through the light-transmissive portion 42 of the auxiliary door 40 and the opening 30h of the main door 30.

Therefore, the user may open the auxiliary door 40 to access the opening 30h of the main door 30, and at the same time, the user may see the inside of the storage chamber through the light-transmissive portion 42 even when the auxiliary door 40 has been closed.

The light-transmissive portion 42 of the auxiliary door 40 may be made of a transparent material such as glass, and thus may be transparent.

In one example, the light-transmissive portion 42 of the auxiliary door 40 may be made of a material whose light transmittance and reflectivity may be selectively controlled, and thus may be switched to between a transparent state and an opaque state depending on the user's manipulation.

Therefore, only when the user wants the transparent state of the light-transmissive portion 42, the light-transmissive portion 42 may be switched to the transparent state, so that the inside of the first storage chamber 21 may be visible to the user. Otherwise, the light-transmissive portion 42 may be maintained in the opaque state.

The opaque state as used herein means including a state in which the inside of the storage chamber is not visible well to the user when the user away from the refrigerator 1 at a typical refrigerator usage distance is looking at the light-transmissive portion 42, and is not defined only as a totally opaque state.

For example, referring to FIG. 1, when the light-transmissive portion 42 of the auxiliary door 40 is in the opaque state, the auxiliary door 40 may be in an opaque black color or a mirror-like state.

The auxiliary door 40 is maintained in the opaque state in this way, and the outer appearance of the refrigerator 1 has a beautiful black mirror-like texture, such that the refrigerator 1 has a simple and beautiful outer appearance.

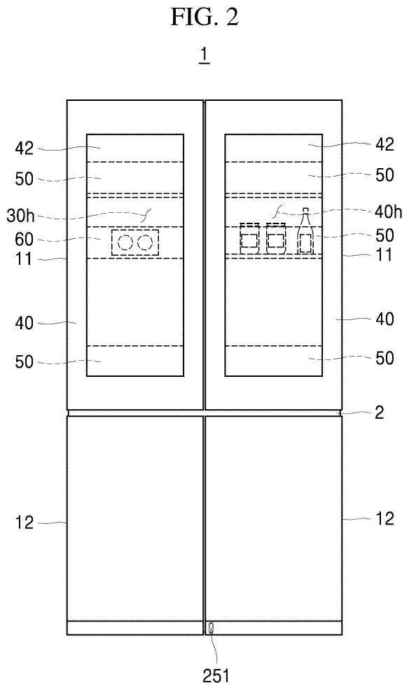

Referring to FIG. 2, when the light-transmissive portion 42 of the auxiliary door 40 is in the transparent state, the user may not only see the inside of the storage chamber through the light-transmissive portion 42, but also see one side of the basket 50 exposed through the opening 30h.

The transparent state as used herein means including a state in which the inside of the storage chamber is visible to the user to some extent when the user away from the refrigerator 1 at a typical refrigerator usage distance is looking at the light-transmissive portion 42, and is not defined only as a totally transparent state.

Therefore, even without opening the auxiliary door 40, the user may identify the groceries stored in the basket 50 or identify the storage status of the basket 50.

When the auxiliary door 40 becomes transparent, the display unit 60 located in rear of the auxiliary door 40 also becomes visible to the user, so that the operating status of the refrigerator 1 displayed on the display unit 60 may be visible to the user out of the refrigerator 1.

When the light-transmissive portion 42 of the auxiliary door 40 is in the transparent state as described above, this state may be referred to as a see-through screen state or a “Smart Insta view” state in which usability is maximized.

One or more door lighting units 72 may be disposed on the auxiliary door 40.

For example, the door lighting unit 72 may be disposed on a rear surface of the auxiliary door 40 and may be positioned adjacent to an upper end area of the light-transmissive portion 42. However, the present disclosure is not limited thereto, and the door lighting unit 72 may be positioned adjacent to a lower end area or a side surface area of the light-transmissive portion 42.

In this way, the door lighting unit 72 may be disposed adjacent to the light-transmissive portion 42 of the auxiliary door 40, such that the user may clearly see the inside of the storage chamber through the light-transmissive portion 42 even in a dark environment.

The door lighting unit 72 may be controlled to be turned on or off depending on the situation regardless of whether the auxiliary door 40 is opened.

A first detection device 251 for detecting a user's human body may be disposed on the first door 11 or the second door 12.

In one example, the first detection device 251 is depicted as being disposed on a lower area of a front surface of the second door 12. However, an embodiment of the present disclosure is not limited thereto.

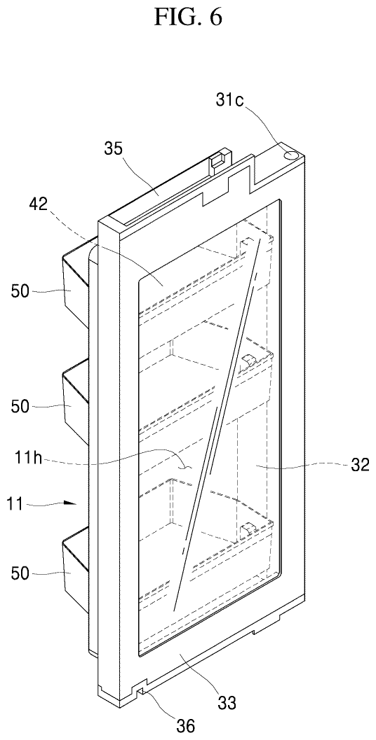

Referring to FIG. 6, the first door 11 may be of an integrated door type, rather than a dual door type in which the door is divided into a main door and an auxiliary door.

In this case, the light-transmissive portion 42 may be formed in the front surface of the first door 11, and an opening 11h may be defined in an inner area of the first door 11 corresponding to or overlapping the light-transmissive portion 42 in the front-rear direction.

Therefore, the user may identify the state of the food stored in the basket 50 in the first door 11 through the opening 11h and the light-transmissive portion 42 without opening the first door 11.

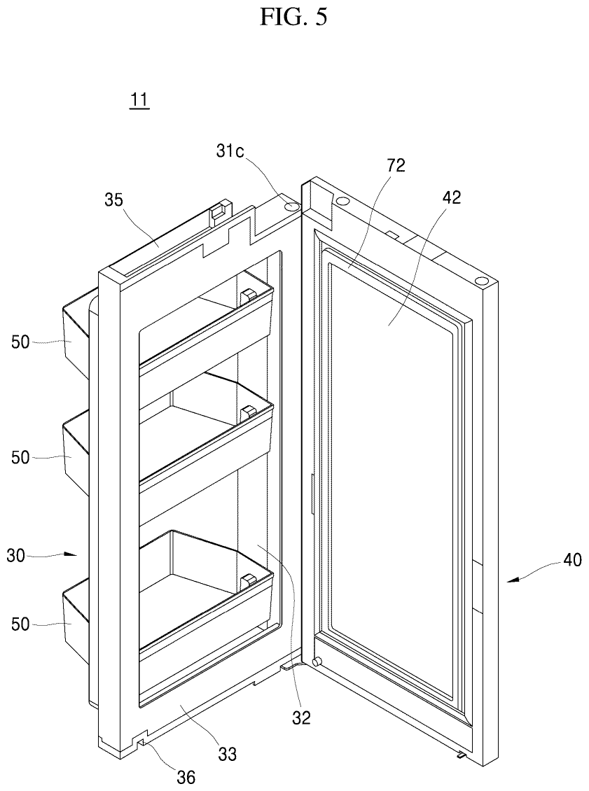

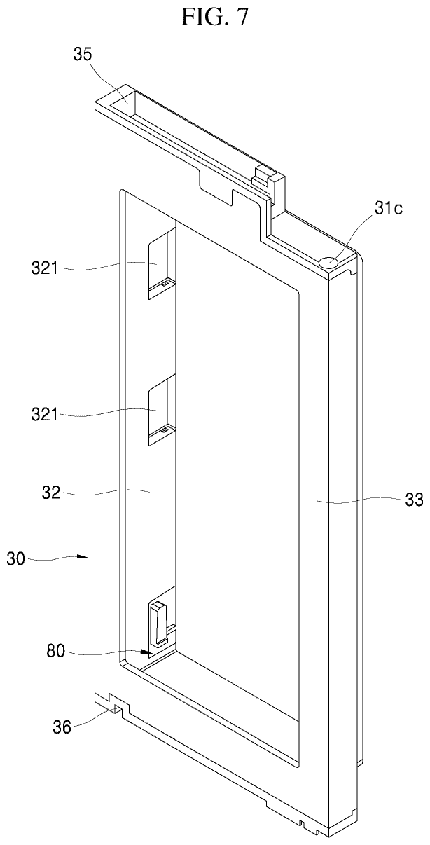

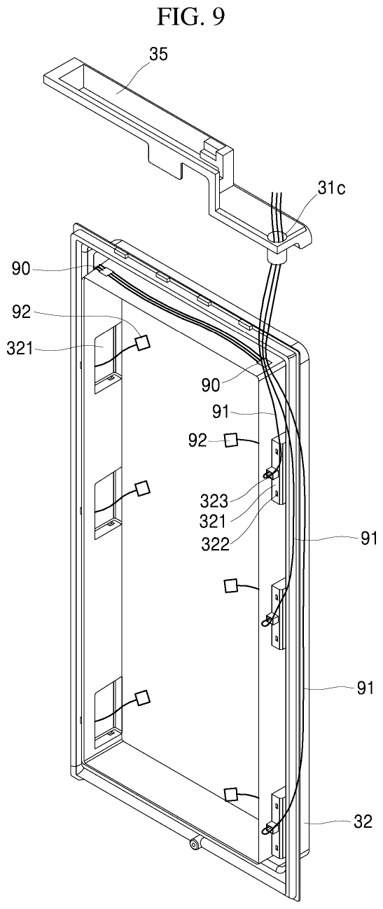

Hereinafter, with reference to FIG. 5 to FIG. 10, a light-source assembly 80 mounted in the first door 11, and a fixing structure in which the basket 50 supported by the light-source assembly 80 is fixed to the first door 11 will be described in more detail.

One or more recesses 321 may be depressed in each of both opposing inner side surfaces of the door liner 32 so as to have a predetermined thickness and be open toward the opening defined in the door liner 32.

For example, a plurality of recesses 321 may be defined in one side surface of the door liner 32 so as to be arranged and spaced apart from each other by a predetermined distance in a vertical direction.

The recesses 321 defined in the both opposing inner side surfaces of the door liners 32 facing each other may have symmetrical shapes and positions with each other.

Each light-source assembly 80 may be received in and detachably coupled to each recess 321.

For example, a partial area of the light-source assembly 80 may be inserted into the recess 321.

In this case, a supporting protrusion 812 protruding outwardly may be formed on a front surface of the light-source assembly 80. The supporting protrusion 812 may not be inserted into the recess 321 but may protrude outwardly of the recess 321.

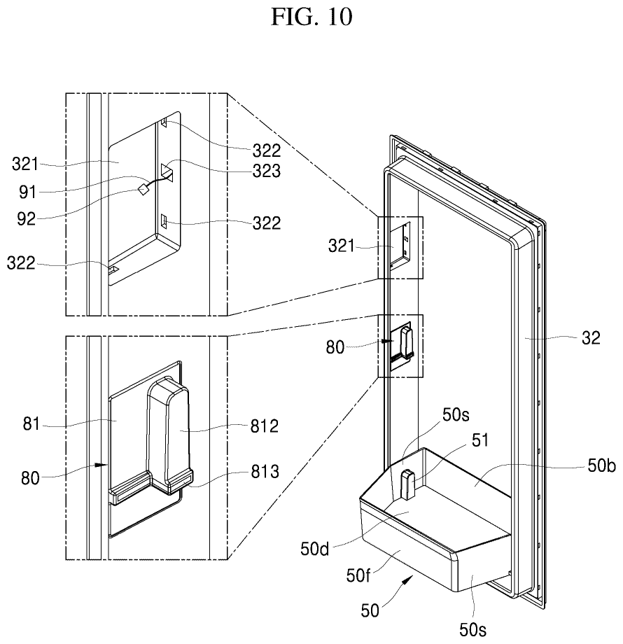

Referring to FIG. 10, a portion of an electrical wire 91 may pass through an electrical wire hole 323 extending through a surface defining the recess 321 and may protrude outwardly of the recess 321. An electrical wire connector 92 may be connected to an end of the portion of the electrical wire 91.

The electrical wire connector 92 may be connected to the light-source assembly 80 and may apply power and various signals thereto so that the light-source assembly 80 may emit light.

Accordingly, the electrical wire connector 92 may be first connected to the light-source assembly 80 and then, the light-source assembly 80 may be inserted into and coupled to the recess 321.

The electrical wire 91 that supplies the power and the signal to the light-source assembly 80 may extend from the cabinet 2 through a hinge connection portion 31c of the upper cap decoration 35 to which the main hinge 31 is connected.

For example, the electrical wire 91 that have passed through the hinge connection portion 31c may pass through an intermediate connector 90 located at each intermediate point and then be electrically connected to the light-source assembly 80 via the electrical wire connector 92 connected to the portion of the wire that passes through the electrical wire hole 323 extending through the surface defining each recess 321.

In this case, the intermediate connector 90 may be optional and omitted.

The inside of the first door 11 may be filled with a foam material for a thermal insulation effect.

Therefore, the remaining portion of the electrical wire 91 passing through the inside of the first door 11 except for the portion of the electrical wire 91 passing through the electrical wire hole 323 extending through the surface of the recess 321 so as to protrude outwardly and the electrical wire connector 92 connected thereto may be fixedly wrapped with the foam material, and thus, an insulating effect may be obtained.

When each light-source assembly 80 has been inserted in and fastened to each recess 321 of the door liner 32 formed in this manner, a pair of light-source assemblies 80 respectively disposed on both opposing inner side surfaces of the door liner 32 may face each other.

Each light-source assembly 80 includes a supporting protrusion 812 protruding outwardly of the recess 321. The supporting protrusion 812 may serve as a supporting structure that supports the basket 50.

The basket 50 may have an open upper surface and have a storage space defined therein for storing therein the food.

The basket 50 may include a front surface 50f, a rear surface 50b facing the front surface 50f, a pair of side surfaces 50s as both opposing side surfaces of the basket 50, and a lower surface 50d opposite to the open upper surface. The storage space of the basket may be defined by the front surface 50f, the rear surface 50b, the pair of side surfaces 50s and the lower surface 50d.

As used herein, a front surface of the basket 50 may refer to the surface of the basket 50 recognized by the user when the first door 11 is opened. A rear surface of the basket 50 may refer to the surface of the basket 50 recognized by the user through the light-transmissive portion 42 when the first door 11 is not opened.

A pair of supported portions 51 protruding upwardly from the lower surface 50d of the basket 50 may be respectively formed at both opposing sides of the basket 50.

The supported portion 51 may be depressed inwardly from an outer end of the side surface 50s of the basket 50.

The supported portion 51 protrudes inwardly from the inner side surface of the basket 50. The supported portion 51 is depressed inwardly from the outer side surface of the basket 50. The supported portion 51 protrudes upwardly from the lower surface of the basket 50. Thus, the supported portion 51 has a hollow shape.

The supported portion 51 of the basket 50 may be mounted on the supporting protrusion 812 of the light-source assembly 80 such that the supporting protrusion 812 is inserted into the hollow of the supported portion 51. Thus, the basket 50 may be fixed to the inner side surface of the door liner 32 of the first door 11.

The basket 50 may be movable in the vertical direction so that the supported portion 51 thereof is mounted on to or removed from the supporting protrusion 812 of the light-source assembly 80.

The hollow of the supported portion 51 may be formed in a shape corresponding to an outer shape of the supporting protrusion 812 so that the supported portion 51 may be mounted on the supporting protrusion 812 and the supporting protrusion 812 may be received in the hollow of the supported portion 51.

For example, an inner diameter of the hollow of the supported portion 51 may be larger than an outer diameter of an outer surface of the supporting protrusion 812, so that the basket 50 may be easily fastened to and detached from the light-source assembly 80.

The light-source assemblies 80 may be respectively disposed on both opposing side surfaces of the basket 50 so as to support lower portions of both opposing side surfaces of the basket 50.

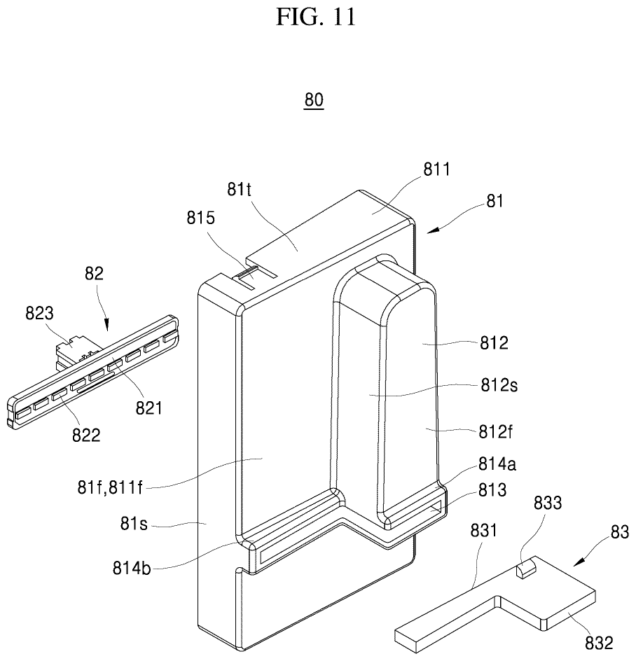

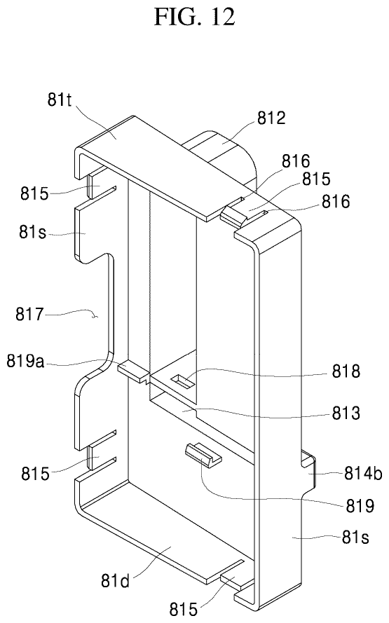

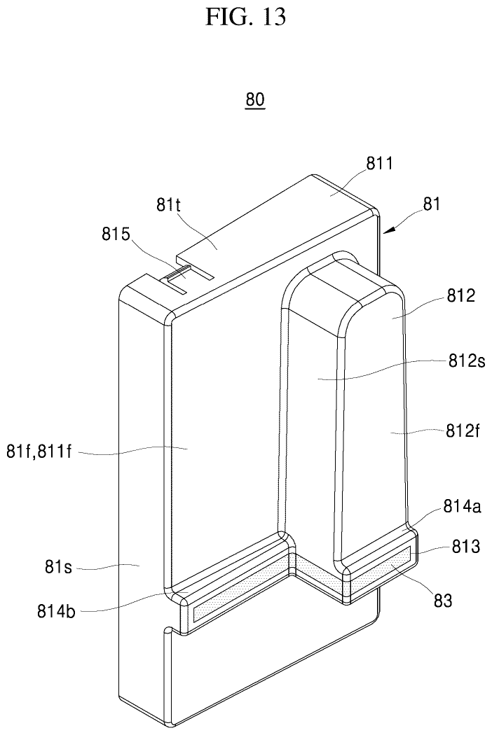

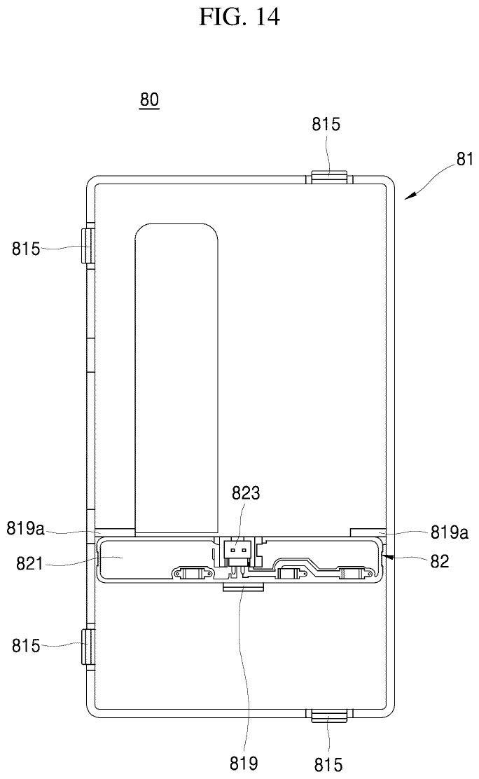

Hereinafter, the light-source assembly 80 will be described in more detail with reference to FIGS. 11 to 15.

The light-source assembly 80 may include a casing 81, and a light source module 82 and a lightguide member 83 fastened to and disposed within the casing 81.

The casing 81 may constitute an outer shape of the light-source assembly 80.

The casing 81 may include a body 811 inserted into the recess 321 and the supporting protrusion 812 which is formed to protrude outwardly of the body 811.

That is, the supporting protrusion 812 may be formed to protrude outwardly from a front surface 81f of the casing 81.

The front surface 81f of the casing 81 may be defined as a surface facing the side surface 50s of the basket 50.

The supporting protrusion 812 may extend in an elongate manner in the vertical direction. A vertical length of the supporting protrusion 812 may be larger than a width in the left-right direction thereof.

For example, the supporting protrusion 812 may be formed to have a roughly trapezoidal cross-sectional shape in which the left-right width decreases as the supporting protrusion 812 extends upwardly.

Accordingly, the supported portion 51 of the basket 50 may be easily fitted with or removed from the supporting protrusion 812.

A position of the supporting protrusion 812 may be closer to one of left and right sides of the front surface 811f of the body 811 than to the other thereof.

For example, a position of the recess 321 formed in the door liner 32 may be closer to one of both opposing sides in the front-back direction of the door liner 32 than to the other thereof.

In this case, when a position of the recess 321 formed in the door liner 32 is closer to a rear side of the door liner 32 than to a front side thereof, a position of the supporting protrusion 812 of the light-source assembly 80 is closer to a front side of the front surface 811f of the body 811 inserted into the recess 321 than to a rear side thereof. Alternatively, when a position of the recess 321 formed in the door liner 32 is closer to a front side of the door liner 32 than to a rear side thereof, a position of the supporting protrusion 812 of the light-source assembly 80 is closer to a rear side of the front surface 811f of the body 811 inserted into the recess 321 than to a front side thereof. Thus, when the light-source assembly 80 has been inserted in and fastened to the recess 321, the supporting protrusion 812 may be positioned at a center position in the front-back direction of the door liner 32.

Accordingly, a position of the supporting structure for supporting the basket 50 may be positioned at the center area in the front-back direction of the door liner 32, thereby supporting the basket 50 more stably.

A first step portion 814a protruding outwardly of a front surface 812f of the supporting protrusion 812 may be formed on a lower area of the front surface 812f of the supporting protrusion 812.

An opening slit 813 opened such that the lightguide member 83 is exposed therethrough may be formed in the first step portion 814a.

The opening slit 813 formed in the first step portion 814a may be formed in a slit shape that extends in an elongate manner in the left-right direction of the supporting protrusion 812.

A second step portion 814b protruding outwardly from the front surface 811f of the body 811 may be formed in the front surface 811f of the body 811.

A length by which the second step portion 814b protrudes outwardly may be similar to or equal to a length by which the first step portion 814a protrudes outwardly.

However, the second step portion 814b may not protrude beyond the supporting protrusion 812.

That is, a thickness in a frontward direction of the supporting protrusion 812 may be greater than a thickness in the frontward direction of each of the first step portion 814a and the second step portion 814b.

An opening slit 813 may be formed in the second step portion 814b so that the lightguide member 83 is exposed therethrough.

The opening slit 813 formed in the second step portion 814b may be formed in a slit shape that extends in an elongate manner in the left-right direction of the supporting protrusion 812.

The second step portion 814b may be positioned at the other side in the left-right direction of the front surface 81f of the body 811 opposite to one side in the left-right direction of the front surface 81f of the body 811 where the supporting protrusion 812 is positioned.

The second step portion 814b may be formed to extend from a side surface 812s of the supporting protrusion 812.

In this case, the opening slit 813 formed in the first step portion 814a and the opening slit 813 formed the second step portion 814b may extend in a continuous manner.

For example, the single opening slit 813 may extend in the continuous manner along the first step portion 814a formed on the front surface 812f of the supporting protrusion 812, the side surface 812s of the supporting protrusion 812, and the second step portion 814b formed on the front surface 811f of the body 811.

In this way, the opening slit 813 is open not only in the frontward direction of the supporting protrusion 812 but also in a lateral direction of the supporting protrusion 812. Thus, the light irradiated through the opening slit 813 may be directed not only in the frontward direction of the light-source assembly 80 but also in the lateral direction thereof.

However, the present disclosure is not limited thereto. The opening slit 813 may be formed in a discontinuous manner so that a partially opened area has a closed form.

Each of the first step portion 814a and the second step portion 814b may protrude toward the side surface of the basket 50. Thus, the lightguide member 83 may be positioned closer to the side surface of the basket 50, so that light loss may be reduced.

A rear surface 81b of the casing 81 may be open so that the light source module 82 and the lightguide member 83 may be inserted through the open rear surface 81b into an inner space of the casing 81.

A hook 815 may be formed at each of an upper surface 81t and a lower surface 81d of the casing 81.

For example, both opposing cut-aways 816 may be defined in each of the upper surface 81t and the lower surface 81d of the casing 81 and may be respectively positioned on both opposing sides of the hook 815. Each of the both opposing cut-aways 816 may be formed by cutting away a portion of each of the upper surface 81t and the lower surface 81d thereof.

Accordingly, the hook 815 may function as an elastic hook having predetermined elasticity.

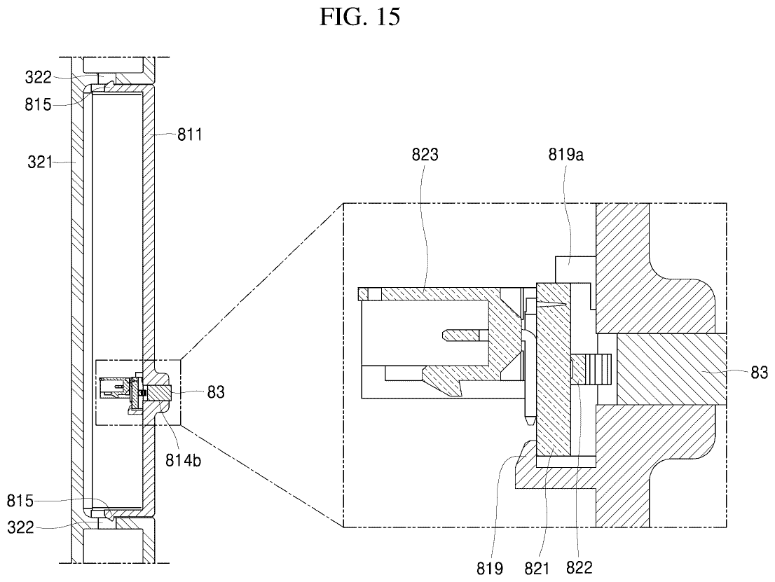

Referring to FIG. 15, the hook 815 formed at each of the upper surface 81t and the lower surface 81d of the casing 81 may be caught with a hook catch 322 formed in each of an upper surface and a lower surface defining the recess 321.

The casing 81 may be fastened to the recess 321 in a hook-fastening scheme, such that the casing 81 may be freely fastened to and detached from the recess 321 without a separate fastening member.

The hook 815 of the casing 81 may be additionally formed in at least one side surface 81s of the casing 81.

Referring to FIG. 10, a hook catch 322 may be additionally formed in a side surface defining the recess 321.

Accordingly, a fastening force between the light-source assembly 80 and the recess 321 may be further increased.

A connector hole 81 communicating with the electrical wire hole 323 extending through the surface defining the recess 321 may be defined in one side surface 81s of the casing 81.

The portion of the electrical wire passing through the electrical wire hole 323 extending through the surface defining the recess 321 may pass through the connector hole 817 of the casing 81 and may be connected to the electrical wire connector 92 which in turn may be connected to the light source module 82.

The opening slit 813 as described above may extend so as to be defined in a rear surface 81b of the casing 81. The lightguide member 83 may be inserted into the opening slit 813 and may be fixed to the casing 81.

The lightguide member 83 may play a role in diffusing or scattering light to guide the light.

For example, the lightguide member 83 may be made of a polymer material such as PMMA. However, an embodiment of the present disclosure is not limited thereto.

The lightguide member 83 inserted into the opening slit 813 may be exposed to the outside through the opening slit 813.

For example, an outer end of the opening slit 813 exposed to the outside may be coplanar with an outer end of the lightguide member 83 exposed to the outside. However, an embodiment of the present disclosure is not limited thereto.

For example, the lightguide member 83 may be formed in a shape corresponding to a shape of the opening slit 813.

A side surface of the lightguide member 83 to which light from the light source module 82 is irradiated among side surfaces of the lightguide member 83 may be defined as one side surface 831. A surface of the lightguide member 83 that is opposite to one side surface 832 and is exposed to the outside through the opening slit 813 among the side surfaces of the lightguide member 83 may be defined as the other side surface 832.

Therefore, the lightguide member 83 may be formed to have a generally flat plate shape. However, the other side surface 832 of the lightguide member 83 exposed through the opening slit 813 may be formed into a shape corresponding to a shape of the opening slit 813.

Therefore, a width in the front-back direction of a portion of the other side surface 832 of the lightguide member 83 corresponding to the first step portion 814a may be larger than a width in the front-back direction of a portion of the other side surface 832 of the lightguide member 83 corresponding to the second step portion 814b.

In this way, a shape of the lightguide member 83 may be changed to conform to the shape of the opening slit 813 formed in the casing 81.

A hook 833 may be formed at an upper surface of the lightguide member 83 and may be caught with a hook catch 818 defined in an upper surface defining a rear area of the opening slit 813, thereby allowing the lightguide member 83 to be easily fastened to and detached from the casing 81 int the hook coupling manner.

The light source module 82 may be disposed in rear of the lightguide member 83.

The light source module 82 may include the substrate 821 that extends in an elongate manner in one direction and one or more light sources 822 arranged along one side surface of the substrate 821.

The light source 822 may be configured to irradiate light of various colors. However, an embodiment of the present disclosure is not limited thereto, and the light source 822 may be configured to irradiate light of one color.

In one example, the light source 822 may be embodied as an RGB LED (Red Green Blue light emitting diode). However, an embodiment of the present disclosure is not limited thereto.

A hook-type fixing structure capable of fixing the substrate 821 may be formed on the rear surface 81b of the casing 81.

For example, a hook-type stopper 819 capable of supporting a lower surface of the substrate 821 and a pair of support ribs 819a capable of supporting an upper surface of the substrate 821 may be formed on the rear surface 81b of the casing 81.

In one example, the hook-type stopper 819 supports the lower surface of the substrate 821 in the upward direction and fixes the substrate 821 so that the substrate does not move backwards. The support rib 819a presses the upper surface of the substrate 821 in a downward direction to strengthen a fastening force between the substrate 821 and the casing 81.

A connector receiver 823 may be formed on the other side surface of the substrate 821. The electrical wire connector 92 may be coupled to the connector receiver 823 and may supply the power and signals thereto.

The light source 822 of the light source module 82 may be aligned horizontally with the lightguide member 83 so that the light source 822 may irradiate the light to one side surface 831 of the lightguide member 83.

Therefore, the light source 822 of the light source module 82 may be positioned to overlap with one side surface 831 of the lightguide member 83 in the horizontal direction.

For example, referring to FIG. 15, it is preferable that the light source 822 of the light source module 82 overlaps with a center area in the vertical direction of one side surface 831 of the lightguide member 83.

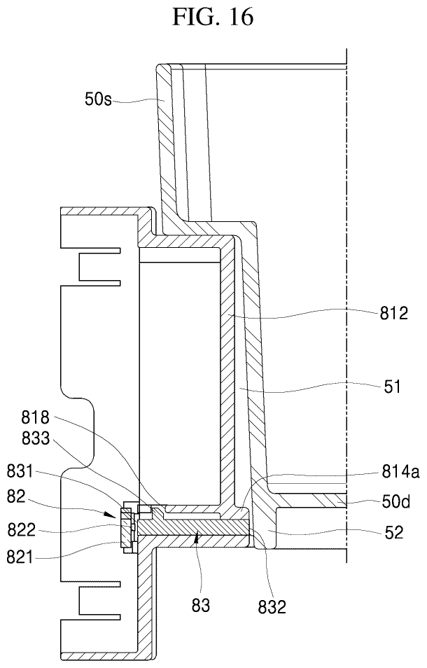

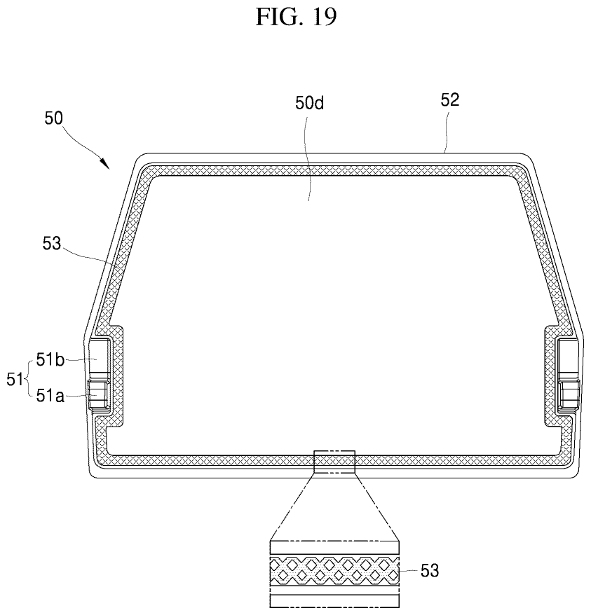

Referring further to FIG. 16 and FIG. 19, the basket 50 may be formed to include a lower rib 52 that protrudes downwardly from and extends along a lower surface edge of the basket 50.

For example, the lower rib 52 of the basket 50 may be formed to extend from the side surface 50s of the basket 50 and protrude downwardly beyond the lower surface 50d.

Each of the light source module 82 and the lightguide member 83 may be positioned to overlap, in the horizontal direction, with a side surface of the lower rib 52 of the basket 50.

That is, one side surface 831 of the lightguide member 83 may face the light source 822 of the light source module 82, and the other side surface 832 of the lightguide member 83 may face the side surface of the lower rib 52 of the basket 50.

Therefore, the light irradiated from the light source 822 may be incident on one side surface 831 of the lightguide member 83 and may then be emitted from the other side surface 832 of the lightguide member 83 and may then be irradiated to the lower rib 52 of the basket 50.

A pattern area 53 including a predetermined pattern may extend along an inner edge of the lower rib 52 and may be formed on the lower surface 50d of the basket 50.

In one example, a corrosion treatment using a corrosion agent may be performed on a mold for forming the basket 50, and then, the pattern area 53 may be formed on the lower surface 50d of the basket 50 using the mold. However, the present disclosure is not limited thereto.

For example, the pattern area 53 may have the predetermined pattern such as a grid pattern. However, the present disclosure is not limited thereto.

The pattern area 53 may function as a light shielding pattern.

Therefore, upon reaching the pattern area 53, the light may not be emitted downwardly of the basket 50.

In this way, the pattern area 53 extends along a perimeter of the inner edge of the lower rib 52. Thus, the light irradiated to the side surface of the basket 50 may be emitted along a shape in which the lower rib 52 extends, and thus, the aesthetics of the illumination effect of the basket 50 may be enhanced.

In order to increase the light shielding effect of the pattern area 53, the pattern area 53 may be replaced with an additional shielding member such as a shielding film, or with a printed shielding layer that absorbs light.

However, the function of the pattern area 53 is not limited thereto. In another embodiment, the pattern area 53 may function as a diffusion pattern in which light is actively scattered in the pattern area 53.

In this case, the pattern area 53 may be patterned in various schemes, including generating a roughness to achieve diffuse reflection, attaching a diffusion tape, or applying a coating liquid.

The supported portion 51 formed at a lower portion of the basket 50 may include a first supported portion 51a and a second supported portion 51b having different vertical dimensions.

For example, the first supported portion 51a may be mounted on the supporting protrusion 812 of the light-source assembly 80. The second supported portion 51b may be mounted on the second step portion 814b of the light-source assembly 80.

Therefore, a vertical length by which the first supported portion 51a is depressed upwardly is greater than a vertical length by which the second supported portion 51b depressed upwardly. Thus, the supported portion 51 may be stably supported on the light-source assembly 80.

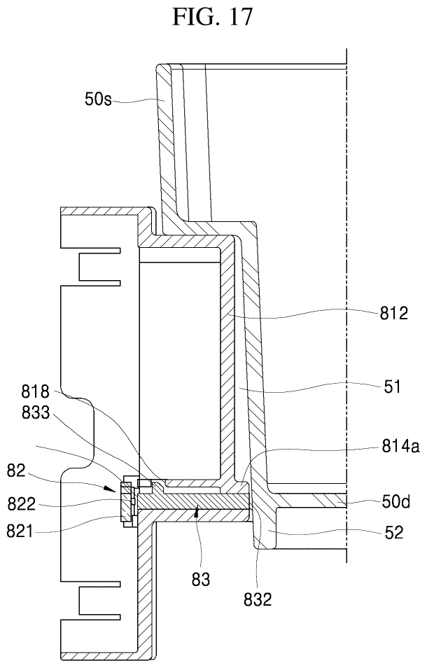

In another embodiment, referring to FIG. 17, the light source module 82 and the lightguide member 83 may be positioned to overlap each other in the horizontal direction with the lower surface 50d of the basket 50.

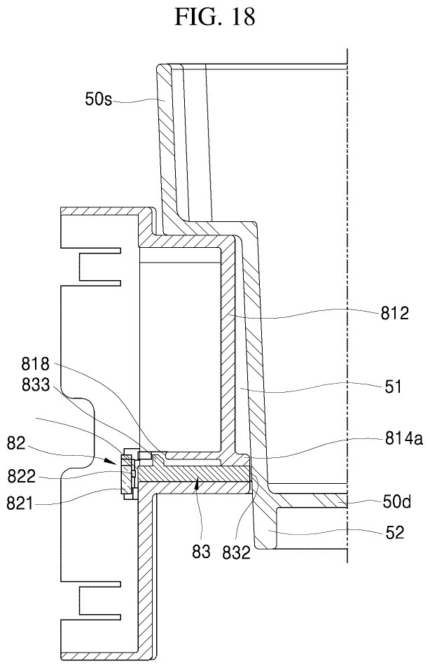

Furthermore, referring to FIG. 18 in still another embodiment, a vertical level of each of the light source module 82 and the lightguide member 83 may be higher than a vertical level of the lower surface 50d of the basket 50.

In this way, depending on which side surface of the basket 50 to which the other side surface 832 of the lightguide member 83 that guides the light irradiates the light, various illumination effects may be implemented.

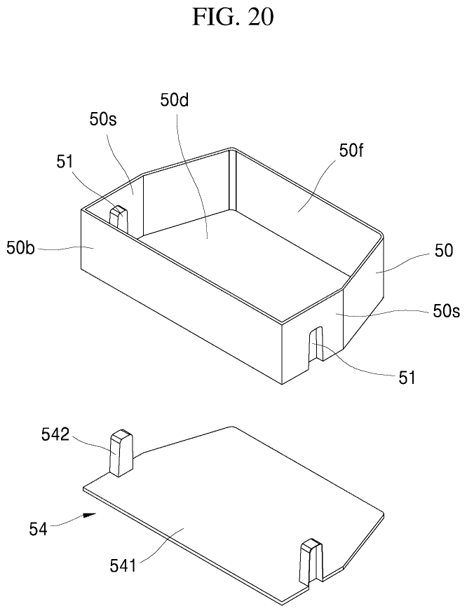

Referring to FIG. 20, the basket 50 may be divided into at least two or more separate structures rather than being embodied as a single integral structure.

For example, a separate base member 54 that supports a side wall of the basket 50 may constitute a bottom of the basket 50.

The base member 54 may be formed to include a plate-shaped support body 541 having a shape corresponding to a shape of the lower surface of the basket 50 and an inserted portion 542 formed at each of both opposing side surfaces of the support body 541.

The inserted portion 542 may be formed in a shape corresponding to a shape of the supported portion 51 so that the inserted portion may be inserted into the hollow of the supported portion 51 of the basket 50.

Furthermore, the inserted portion 542 may be hollow in a shape corresponding to a shape of the supporting protrusion 812 so that the supporting protrusion 812 of the light-source assembly 80 may be inserted into the hollow of the inserted portion 542 while the inserted portion 542 is mounted on the supporting protrusion 812.

Therefore, the inserted portion 542 of the base member 54 may be mounted on the supporting protrusion 812 of the light-source assembly 80, and then the supported portion 51 of the basket 50 may be additionally mounted on the inserted portion 542 which may be inserted into the hollow of the supported portion 51. In this way, the basket 50 may be fixed to the door.

Accordingly, according to the present disclosure, the base member 54 is first mounted on the supporting protrusion 812. The basket 50 is additionally detachable from the base member 54. Thus, cleaning of the basket or food storage therein may be facilitated by removing only the basket 50 from the base member 54.

For example, the base member 54 may be made of the same material as that of the lightguide member, and thus the base member 54 may play a role of guiding the light.

Furthermore, in another embodiment, the basket 50 may be formed as a single integral structure, wherein different materials may constitute different areas of the basket 50.

For example, the basket 50 may be formed using a double injection structure such that upper and lower areas of the basket 50 may be made of different materials. In this regard, the lower area may be made of a material that can guide the light, thereby reducing loss of light.

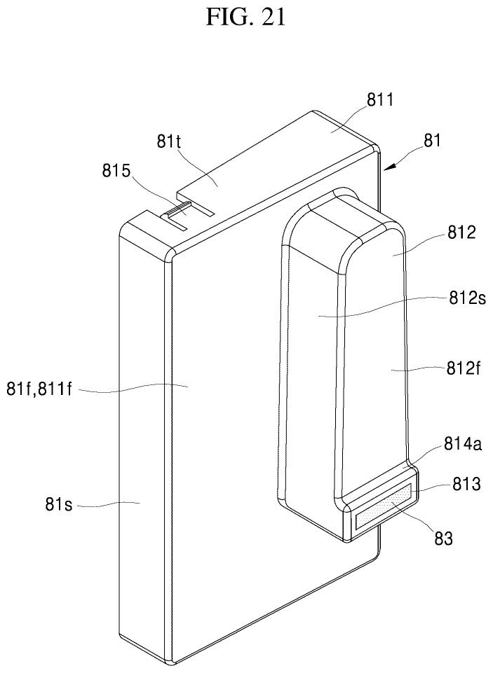

Hereinafter, various embodiments of the light-source assembly 80 will be described with reference to FIGS. 21 to 30.

Referring to FIG. 21, the opening slit 813 may be defined in the first step portion 814a formed on the supporting protrusion 812. Thus, the lightguide member 83 may be exposed to the outside only through the opening slit 813 defined in the supporting protrusion 812.

According to the embodiment of FIG. 21, an area of the lightguide member 83 from which the light is emitted may be reduced so that the light may be emitted through that area in a concentrated manner. Thus, the light may be irradiated to a partial area of the basket 50 in a concentrated manner.

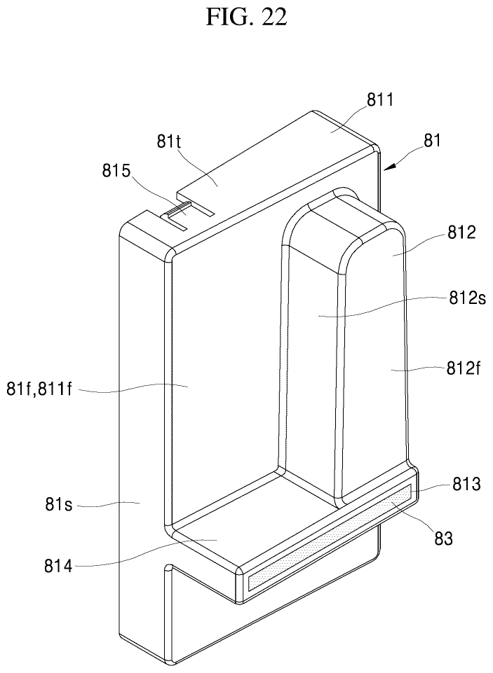

Referring to FIG. 22, a step portion 814 protruding frontwards from the front surface of the supporting protrusion 812 may extend outwardly of the supporting protrusion 812 in a lateral manner. Thus, the step portion 814 may protrude frontwards from the front surface 811f of the body 811.

The step portion 814 formed on the supporting protrusion 812 and the body 811 may protrude frontwards beyond the front surface than the supporting protrusion 812.

Accordingly, a portion of the step portion 814 formed on the body 811 may protrude frontwards beyond the supporting protrusion 812. Thus, the opening slit 813 may have no bent portion but may extend in a straight shape in a lateral direction.

Accordingly, the other side surface 832 of the lightguide member 83 may extend in a straight shape in a lateral direction.

According to the embodiment of FIG. 22, the other side surface 832 of the lightguide member 83 exposed through the opening slit 813 defined in the step portion 814 formed on the body 811 as well as the supporting protrusion 812 may be closer to the side surface of the basket 50, so that the loss of light may be further reduced.

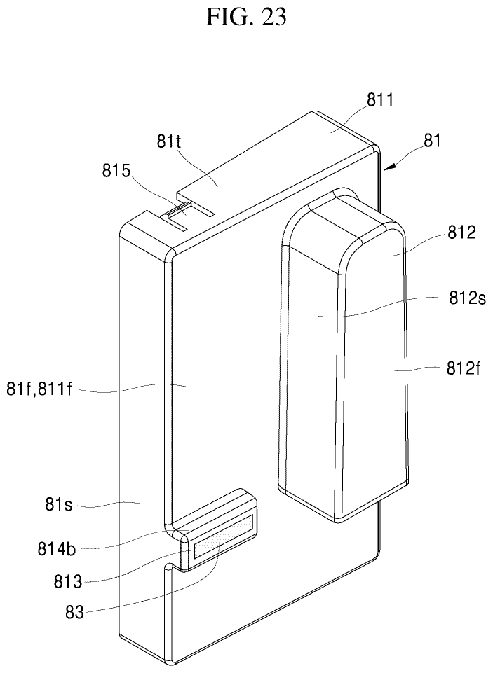

Referring to FIG. 23, a separate opening slit 813 is not formed in the supporting protrusion 812. The second step portion 814b having the opening slit 813 defined therein may be formed on a partial area of the front surface 811f of the body 811.

Accordingly, the lightguide member 83 may be exposed to the outside only through the opening slit 813 defined in the second step portion 814b.

According to the embodiment of FIG. 23, various illumination effects desired by the user may be imparted to the basket 50. Thus, various decoration effects may be achieved.

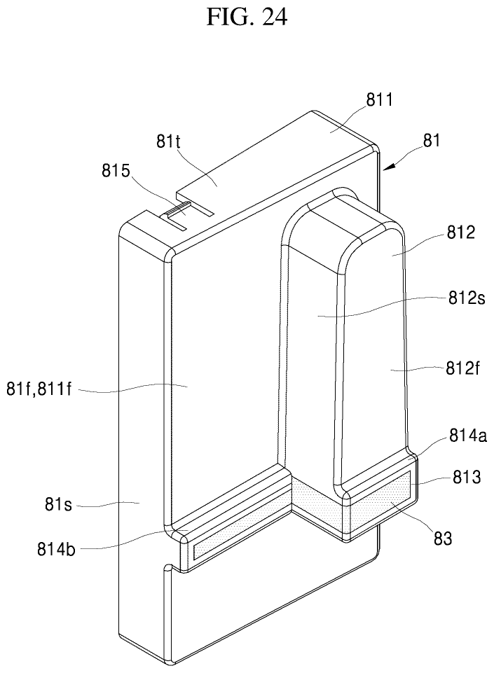

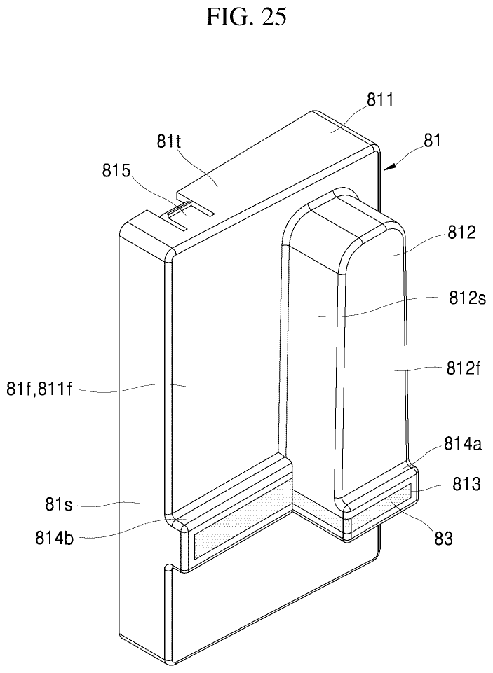

According to FIG. 24 and FIG. 25, a vertical dimension of the opening slit 813 formed in the supporting protrusion 812 and a vertical dimension of the opening slit 813 formed in the body 811 may be different from each other.

Referring to FIG. 24, the vertical dimension of the opening slit 813 formed in the supporting protrusion 812 may be larger than the vertical dimension of the opening slit 813 formed in the body 811.

Therefore, an area size per a unit width of the lightguide member 83 exposed through the supporting protrusion 812 to the outside may be larger than an area size per a unit width of the lightguide member 83 exposed through the body 811 to the outside.

Referring to FIG. 25, the vertical dimension of the opening slit 813 formed in the body 811 may be greater than the vertical dimension of the opening slit 813 formed in the supporting protrusion 812.

Therefore, an area size per a unit width of the lightguide member 83 exposed through the supporting protrusion 812 to the outside may be smaller than an area size per a unit width of the lightguide member 83 exposed through the body 811 to the outside.

According to the embodiments of FIG. 24 and FIG. 25, a partial area of the basket 50 to which a larger amount of light is to be irradiated may be specified, and then the larger amount of light may be irradiated to the specific partial area through the opening slit 813 having the greater vertical dimension. Thus, various illumination effects desired by the user may be imparted to the basket 50. Thus, various decoration effects may be achieved.

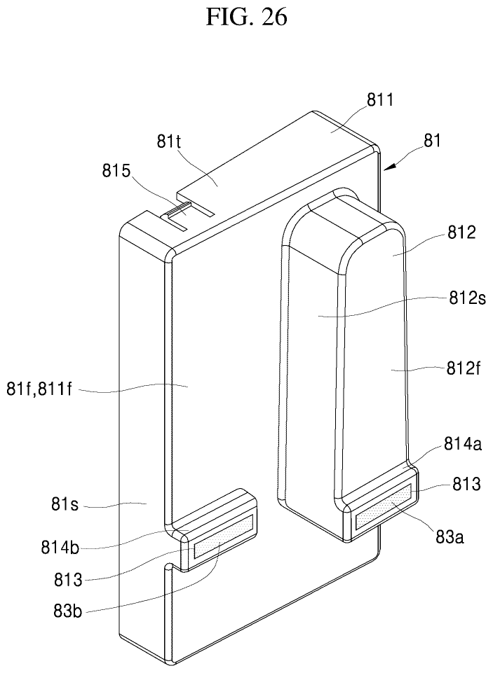

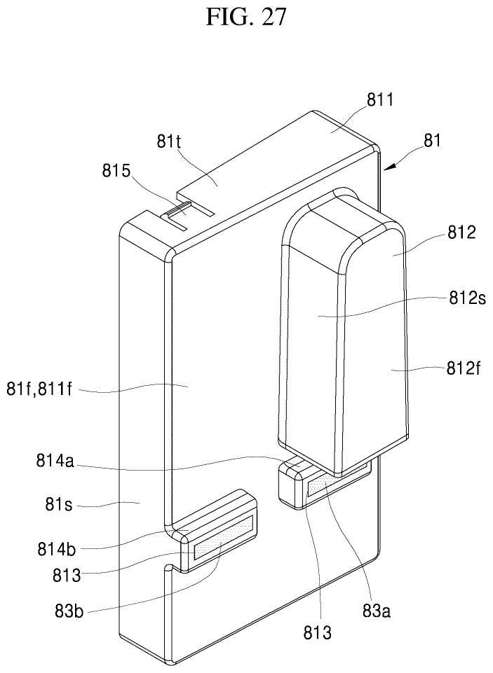

Referring to FIG. 26 and FIG. 27, the light-source assembly 80 may include a plurality of light source modules that are individually controlled.

For example, referring to FIG. 26, a first lightguide member 83a exposed through the opening slit 813 of the first step portion 814a of the supporting protrusion 812 may receive light irradiated from a first light source module.

Furthermore, a second lightguide member 83b exposed through the opening slit 813 of the second step portion 814b of the body 811 spaced from the supporting protrusion 812 may receive light irradiated from a second light source module.

Referring to FIG. 27, a separate opening slit 813 is not formed in the supporting protrusion 812. The opening slit 813 is defined in the first step portion 814a formed in an area of the body 811 positioned under the supporting protrusion 812 so that the first lightguide member 83a may be exposed to the outside through the opening slit 813.

Furthermore, the opening slit 813 is defined in the second step portion 814b formed on the front surface of the body 811 and spaced apart from the first step portion 814a in the lateral direction so that the second lightguide member 83b may be exposed to the outside through the opening slit 813.

In this case, the first light source module and the second light source module may be controlled individually. For example, the first light source module and the second light source module may be turned on or off individually, or colors of light beams respectively emitted therefrom may be different from each other. Thus, the light beam emitted through the first light guide member 83a and the light beam emitted through the second light guide member 83b may be controlled individually and irradiated to the basket.

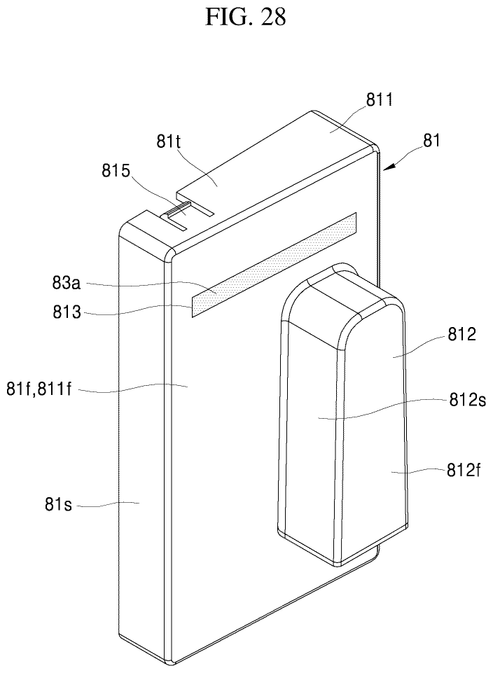

Referring to FIG. 28 to FIG. 30, the opening slit 813 may be positioned at a vertical level higher than a vertical level of the supporting protrusion 812.

When the step portion having the opening slit 813 defined therein is formed so that the opening slit 813 is positioned at a position protruding frontwards beyond the front surface 811f of the body 811, the step portion may interfere with the supported portion 51 of the basket 50 mounted on the supporting protrusion 812. For this reason, the opening slit 813 may not be defined in a separate step portion that protrudes frontwards beyond the front surface but may be directly defined in the front surface 811f of the body 811.

Referring to FIG. 28, the opening slit 813 is defined in a portion of the front surface 811f of the body 811 located on top of the supporting protrusion 812. The first lightguide member 83a that receives the light from the first light source module may be exposed to the outside through the opening slit 813.

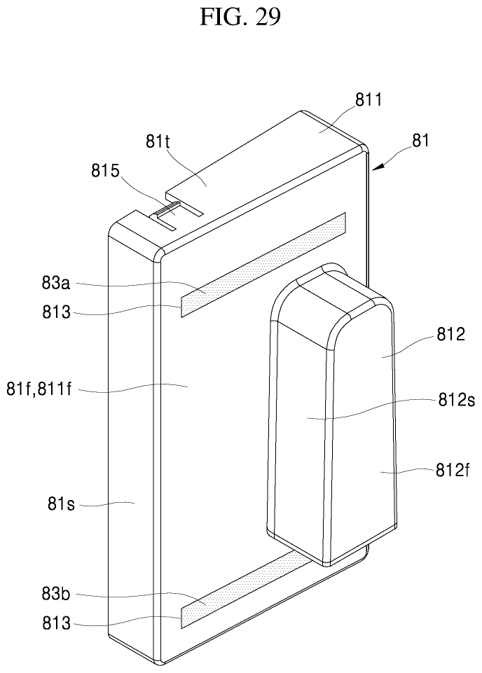

Referring to FIG. 29, the opening slit 813 is additionally defined in a portion of the front surface 811f of the body 811 positioned under the supporting protrusion 812. The second lightguide member 83b that receives light from the second light source module may be exposed to the outside through the opening slit 813.

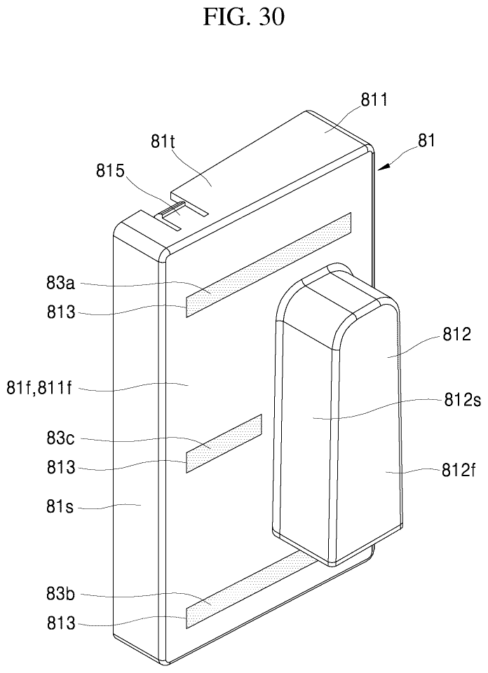

Referring to FIG. 30, the opening slit 813 is additionally defined in a portion of the front surface 811f of the body 811 located on one side of the supporting protrusion 812. A third lightguide member 83 that receives light from a third light source module may be exposed to the outside through the opening slit 813.

In this case, the first light source module, the second light source module, and the third light source module may be controlled individually. For example, the first light source module, the second light source module, and the third light source module may be turned on or off individually, or colors of light beams respectively emitted therefrom may be different from each other. Therefore, the light beams respectively emitted through the first lightguide member 83a, the second lightguide member 83b, and the third lightguide member 83 may be individually controlled and irradiated to the basket.

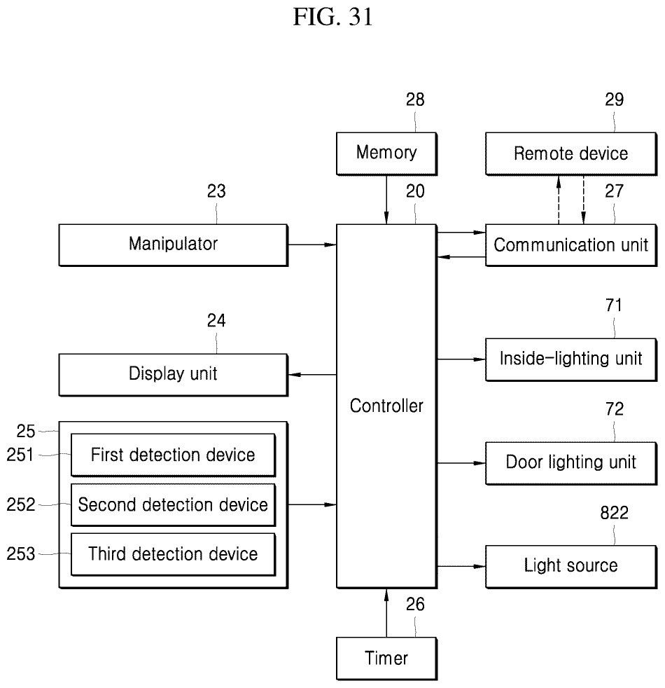

Hereinafter, a block diagram showing flow of a control signal of a refrigerator is described with reference to FIG. 31.

As described above, the refrigerator 1 may include illumination devices such as the light source 822 that irradiates light to the basket 50, the inside-lighting unit 71, and the door lighting unit 72.

The illumination devices may be turned on/off under control of a controller 20 provided in the refrigerator 1.

For example, an operation of each of the illumination devices may be controlled via manipulation of a manipulator 23 by a user.

The manipulator 23 may be provided on one side of the refrigerator 1. In one example, the manipulator 23 may be provided on one side of the cabinet 2 or on the door.

Furthermore, the manipulator 23 may be provided in the display unit 60 mounted on the main door 30 as described above.

The user may set the operation status such as an operation time, an operation condition, and a color of emitted light of each of the illumination devices via the manipulation of the manipulator 23.

Furthermore, the user may set the operation status such as an operation time, an operation condition, and a color of emitted light of each of the illumination devices using a remote device 29 spaced away from the refrigerator 1.

The refrigerator 1 may communicate with the remote device 29 through a communication unit 27 connected to the controller 20. The user may control the operation of each of the illumination devices using the remote device 29.

The communication unit 27 can communicate with the remote device 2 and/or a server that manages the home appliances in various schemes.

For example, the communication unit 27 may employ a communication scheme including a wired scheme, a wireless scheme, a short-range communication (Bluetooth, Wi-Fi, Zigbee, NFC), etc.

The remote device 29 may be embodied as various devices capable of communication, such as a dedicated terminal, a mobile phone, a tablet, a portable PC, a desktop PC, a remote control, a Bluetooth speaker, etc.

The user may set the operation status such as an operation time, an operation condition, and a color of emitted light of each of the illumination devices via the manipulation of the remote device 2.

In one example, the user may perform simple manipulation and setting via an application or a dedicated program installed on the user's mobile phone.

The refrigerator 1 may further include a timer 26 that may count an elapsed time after a specific event occurs.

In one example, the illumination devices may operate based on a detection result by a detection unit 25.

In one example, the detection unit 25 may include one or more detection devices including a first detection device 251 as a proximity detection device that measures a distance therefrom to the user and senses whether the user is close to the refrigerator, a second detection device 252 as a knock detection device that detects a door knock manipulation of the user, and a third detection device 253 as an illuminance detection device that senses whether the user is close to the refrigerator based on change in illuminance.

For example, the detection devices may use various sensors such as an infrared sensor, an ultrasonic sensor, or a laser sensor.

The detection unit 25 may be provided on one side of the cabinet 2 or the door, and may be disposed at various locations to detect the proximity of the user thereto. A plurality of detection units may be positioned at different locations.

For example, when the user is close to the refrigerator 1 at a reference distance therefrom in order to use the refrigerator 1, the first detection unit 251 may detect this proximity of the user thereto and transmit a signal indicating this proximity to the controller 20 to turn on the illumination devices.

Furthermore, when the user moves away from the refrigerator 1, the first detection unit 251 may detect this movement away therefrom and transmit a signal indicating this movement away to the controller 20 to turn off the illumination devices.

The second detection unit 252 may detect the user's door knock manipulation and transmit a signal indicating this door knock to the controller 20 to turn on or off the illumination devices. The third detection unit 253 may detect the change in illuminance, and transmit a signal indicating the change in illuminance to the controller 20 to turn on or off the illumination devices.

The refrigerator 1 may further include a display unit 24.

The display unit 24 may be provided in the display unit 60 mounted on the main door 30 as described above.

In one example, the display unit 24 may include a touch panel that allows a command from the user to be input thereto via a user's touch thereon, or a display panel for outputting a screen.

The refrigerator 1 may further include a memory 28.

For example, color information of light emitted from the illumination device operating in a specific situation, and operation information of a specific illumination device may be stored in the memory 28 and provided therefrom to the controller 20.

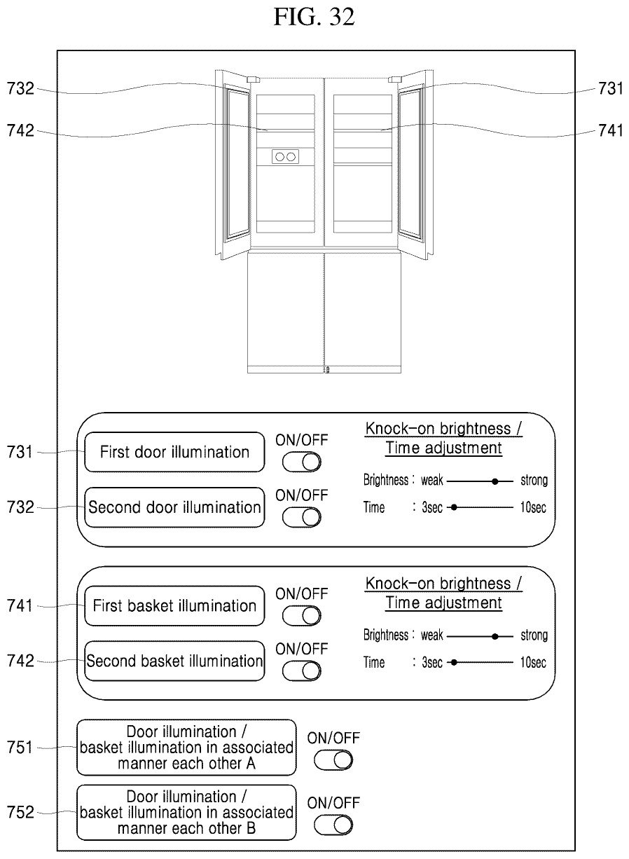

FIG. 32 is a diagram showing a screen displayed on the remote device or the display unit.

For example, a first door illumination device 731 may refer to an illumination device mounted on the auxiliary door of an upper right door, and a second door illumination device 732 may refer to an illumination device mounted on an auxiliary door of an upper left door.

In addition, a first basket illumination device 741 may refer to an illumination device for irradiating light to the basket of the upper right door, and a second basket illumination device 742 may refer to an illumination device for irradiating light to the basket of the upper left door.

In this case, settings such as a knock-on brightness and a time setting related to the second detection device 252 may be set.

In addition, an association operation between the door illumination device and the basket illumination device under various situations may be set. The various situations may include a scenario A 751 where the door illumination device and the basket illumination device operate in an associated manner with each other, and a scenario B 752 where the door illumination device and the basket illumination device operate in an associated manner with each other.

For example, a scenario may be set in which as soon as the first detection device 251 has detected the user's proximity to the refrigerator, the first door illumination device 731 is configured to emit light, and, subsequently, 3 seconds later, the second basket illumination device 742 is configured to emit light.

In another example, a scenario may be set in which as soon as the second detection device 252 has detected the user's door knock manipulation, the first door illumination device 731 is configured to emit light of a red color, and subsequently, or simultaneously, the second basket illumination device 742 is configured to emit light of the red color or a complementary color to the red color.

In still another example, a scenario may be set in which as soon as the third detection device 253 has detected change in illuminance, each of the second door illumination device 732 and the first basket illumination device 741 is configured to emit light.

According to the present disclosure, the user can see the inside of the storage chamber through the front surface of the door, the various types of detection devices may be included in the refrigerator, and the light source may be turned on or off based on the signal from the detection device. Thus, the illumination effect of illuminating the basket may be implemented according to the on or off of the light source even when the door is in the closed state, so that an excellent decoration effect may be provided without unnecessary leakage of cold air.

Furthermore, according to the present disclosure, the lighting unit may be provided in the storage chamber or in the door, and the controller may control the on/off of each of the light source and the lighting unit individually or in association with each other based on the signal from the detection device or the remote device. Thus, a more excellent decoration effect may be provided in various situations and in various schemes.

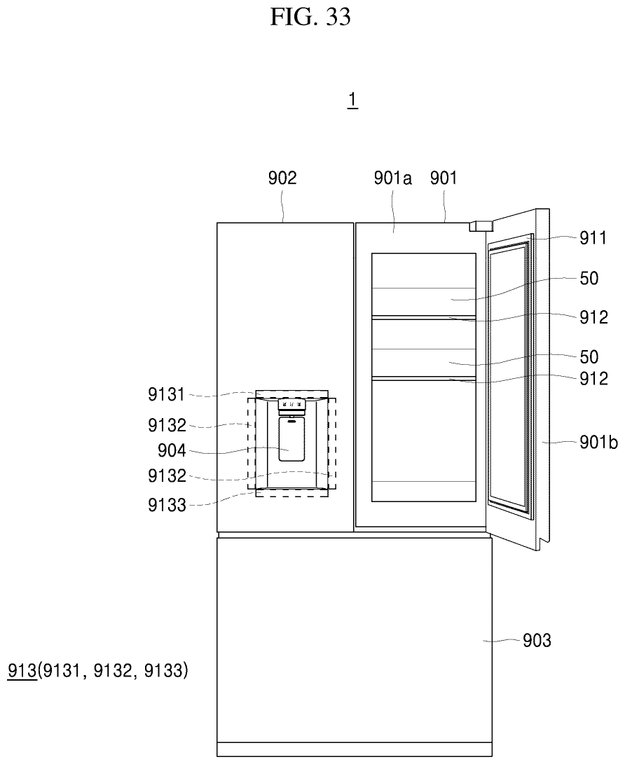

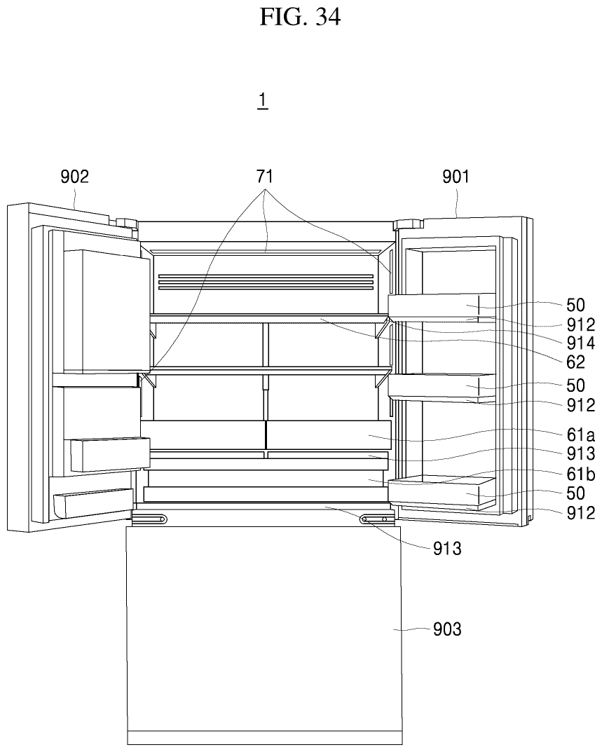

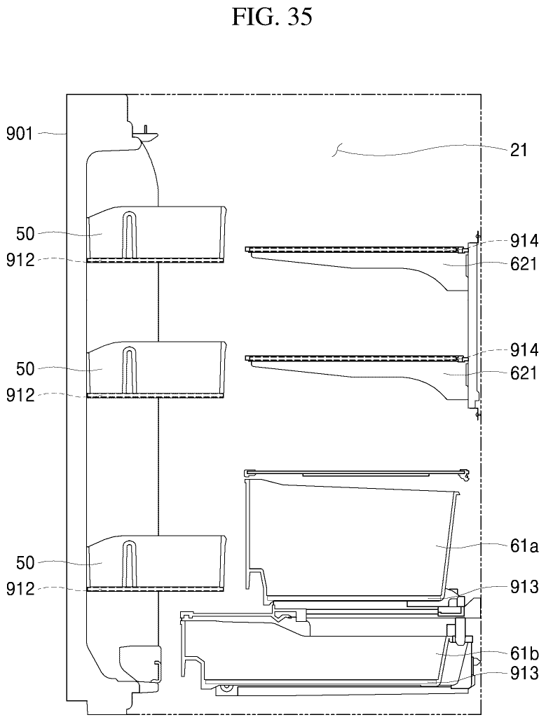

Hereinafter, a refrigerator according to another embodiment will be described with further reference to FIGS. 33 to 36. Additional descriptions of contents duplicate with the contents as described above will be omitted, and the omitted contents may be applied to the refrigerator according to another embodiment as described below.

The refrigerator 1 according to another embodiment may include a first door 901 and a second door 902 that open and close the first storage chamber 21, and a third door 903 that open and close the second storage chamber 22. The first storage chamber 21 may be disposed on top of the second storage chamber. Each of the first door 901 and the second door 902 may be a pivotable door constructed to pivot to open and close the opened front surface of the first storage chamber 21. The third door 903 may be a drawer-type door constructed to extend or retract in a front-rear direction to open and close the opened front surface of the second storage chamber 22.

The first door 11 may be of a dual door type in which the first door includes a main door 901a that opens and closes the first storage chamber 21 and an auxiliary door 901b that is pivotally disposed in front of the main door 901a to open and close an open front surface of the main door 901a. A door illumination device 911 may be mounted on the auxiliary door 901b. The door illumination device 911 may be the door lighting unit 72 as described in the previous embodiment. One or more basket assemblies 50 may be mounted on the main door 901a, and a basket illumination device 912 may be disposed on each basket assembly 50. The basket illumination device 912 may be embodied as a supporting protrusion 812 including a light source 822 as described in the previous embodiment. However, an embodiment of the present disclosure is not limited thereto. For example, the basket illumination device 912 may be disposed on a lower surface or a side surface of the basket assembly 50 to irradiate light to the basket assembly 50 and may be implemented in a variety of illumination schemes.

One or more inside-lighting units 71 may be disposed inside the first storage chamber 21 to illuminate the inside of the first storage chamber 21.

Furthermore, one or more storage target receivers 61 capable of storing therein food may be disposed in the first storage chamber 21. For example, the one or more storage target receivers 61 may include a first storage target receiver 61a and a second storage target receiver 61b disposed under the first storage target receiver 61a. A storage target receiver illumination device 913 may be disposed in each of the first storage target receiver 61a and the second storage target receiver 61b. The storage target receiver illumination device 913 may be embodied as a supporting protrusion 812 including a light source 822 as described above in the previous embodiment. However, an embodiment of the present disclosure is not limited thereto. For example, the storage target receiver illumination device 913 may be disposed on a lower surface or a side surface of each of the first storage target receiver 61a and the second storage target receiver 61b to irradiate light to each of the first storage target receiver 61a and the second storage target receiver 61b and may be implemented in a variety of illumination schemes.

Each of the first storage target receiver 61a and the second storage target receiver 61b may be embodied as a drawer-type storage target receiver that may retract or extend in the forward and backward directions. Each of the first storage target receiver 61a and the second storage target receiver 61b may retract or extend in the forward and backward directions while being guided along rails respectively located on both opposing side surfaces of an inner side wall defining the first storage chamber. In one example, each storage target receiver illumination device 913 may be fixed to the rail and irradiate light to each of the first storage target receiver 61a and the second storage target receiver 61b. Furthermore, in another example, each storage target receiver illumination device 913 may be fixed to the inner wall defining the first storage chamber 21 and irradiate light to each of the first storage target receiver 61a and the second storage target receiver 61b. In this case, the storage target receiver illumination device 913 may be fixed to the rail or the inner side wall defining the first storage chamber 21 and may be positioned so as not to interfere with the extending or retracting movement in the front-rear direction of each of the first storage target receiver 61a and the second storage target receiver 61b.

Furthermore, one or more shelves 62 capable of supporting food thereon may be disposed in the first storage chamber 21. A shelf illumination device 914 may be disposed on the shelf 62. The shelf illumination device 914 may be embodied as a supporting protrusion 812 including a light source 822 as described above in the previous embodiment. However, an embodiment of the present disclosure is not limited thereto. For example, the shelf illumination device 914 may be fixed to a lower surface or a side surface of the shelf 62 and irradiate light to the shelf 62 and may be implemented in a variety of illumination schemes.

The shelf 62 may be fixed by one or more shelf fixing members 621 that are mounted on an inner rear wall or an inner side wall defining the first storage chamber 21 and fix the shelf 62. The shelf fixing member 621 may support the shelf 62 in a cantilever manner. In one example, the shelf illumination device 914 may be fixed to the shelf fixing member 621 and irradiate light to a side surface of the shelf 62. Furthermore, in another example, the shelf illumination device 914 may be fixed to the inner side wall defining the first storage chamber 21 and irradiate light to the shelf 62.

In one example, the second door 902 may include a dispenser 904 that allows a user to withdraw ices or to discharge water without opening the door. A dispenser illumination device 913 may be disposed on at least one side of the dispenser 904. The dispenser illumination device 913 may be embodied as a supporting protrusion 812 including a light source 822 as described above in the previous embodiment. However, an embodiment of the present disclosure is not limited thereto. For example, the dispenser illumination device 913 may be fixed to one or more of an upper surface, a lower surface, and a side surface of the dispenser 904 and may irradiate light to the dispenser 904 and may be implemented in various illumination schemes. In this case, a first dispenser illumination device 9131 may be disposed on the upper surface of the dispenser 904, and a pair of second dispenser illumination devices 9132 may be respectively disposed on both opposing side surfaces of the dispenser 904, and a third dispenser illumination device 9133 may be disposed on the lower surface of the dispenser 904. For example, when the user approaches the refrigerator 1 and the proximity sensor detects this approach, all of the first dispenser illumination device 9131, the second dispenser illumination device 9132, and the third dispenser illumination device 9133 may be configured to be turned on. Furthermore, in another example, the dispenser illumination device 913 and an illuminance sensor of the refrigerator 1 may operate in an associated manner with each other. In this case, when the illuminance is high, all of the first dispenser illumination device 9131, the second dispenser illumination device 9132, and the third dispenser illumination device 9133 may be configured to be turned on. However, when the illuminance is low, only some of the first dispenser illumination device 9131, the second dispenser illumination device 9132, and the third dispenser illumination device 9133 may be configured to be turned on.

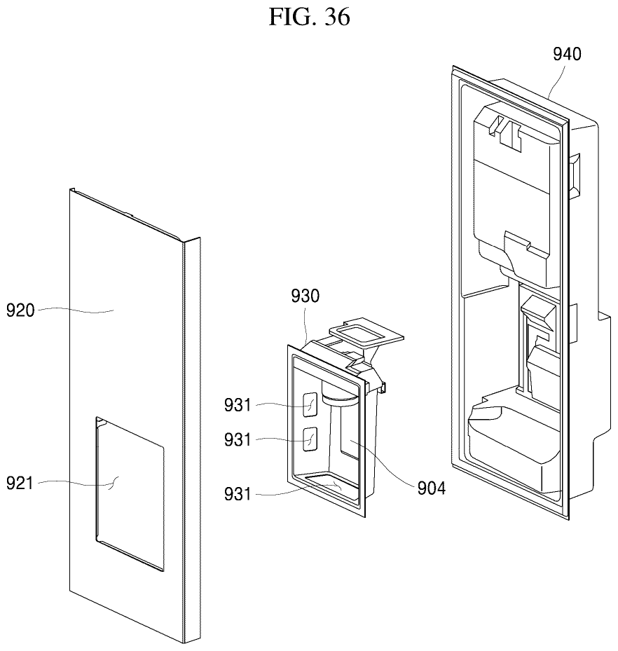

In one example, referring to FIG. 36, the second door 902 may include a front plate 920 constituting an outer appearance thereof, and a door liner 940 disposed in rear of the front plate 920 constituting a substantial body of the second door 902. A dispenser housing 930 in which a dispenser 904 is received may be disposed between the front plate 920 and the door liner 940. The dispenser housing 930 may be mounted and accommodated in the door liner 940. The front plate 920 may have a first opening 921 defined therein that may expose the dispenser 904 to the outside. The dispenser housing 930 may have a second opening 931 defined in at least one of an upper surface, a lower surface, and a side surface thereof. The dispenser illumination device 913 may be disposed in the second opening 931.

The second opening 931 and the dispenser illumination device 913 mounted in the second opening 931 may not be directly exposed to the outside through the first opening 921. For example, the second openings 931 respectively defined in the upper surface and the lower surface of the dispenser housing 930 may face each other, and the second openings 931 respectively defined in both opposing side surfaces thereof may face each other. The dispenser illumination device 913 may be fixedly embedded in a thermal insulation material as a foam material disposed between the dispenser housing 930 and the door liner 940. The light from the dispenser illumination device 913 may be emitted to the outside through the second opening 931. When the dispenser illumination device 913 is turned on, the light from the dispenser illumination device 913 may be directed through the second opening 931 and then through the first opening 921 to the outside.

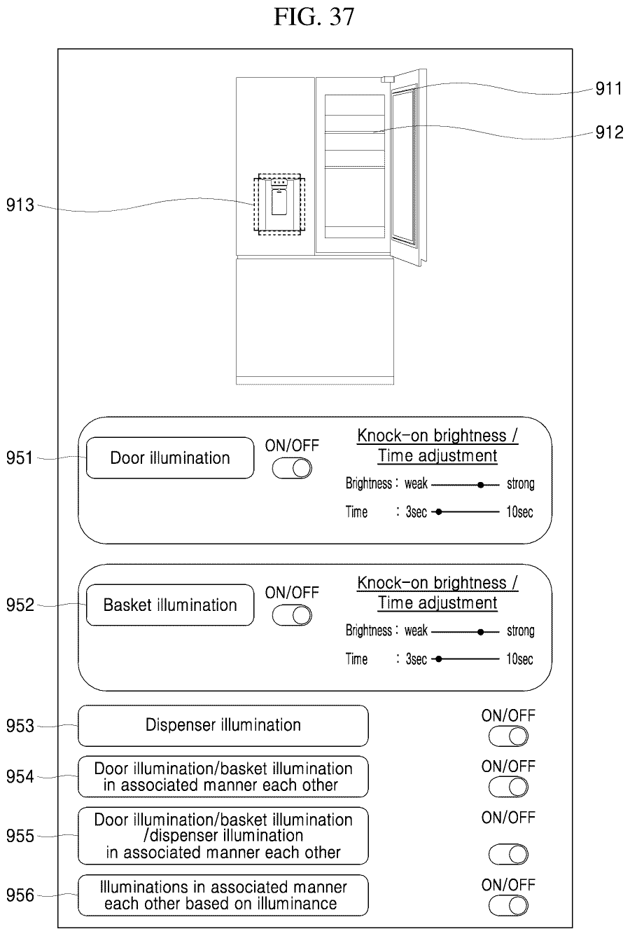

FIG. 37 is a diagram showing a screen according to still another embodiment implemented in the remote device or the display unit.

For example, the door illumination device 911 may refer to an illumination device mounted on the auxiliary door of the upper right door, and the basket illumination device 912 may refer to an illumination device mounted on the basket assembly of the upper right door. The dispenser illumination device 913 may refer to an illumination device mounted on the upper left door. However, the present disclosure is not limited thereto, and each of the door illumination device 911 and the basket illumination device 912 may be mounted on the upper left door or the lower door. Furthermore, the dispenser illumination device 913 may be mounted on the upper right door.

Each of the door illumination device 911, the basket illumination device 912, and the dispenser illumination device 913 may be configured to be turned or off in an associated manner with various types of the detection devices 25, such as the first detection device 251, the second detection device 252, and the third detection device 253 as described above.

For example, a door illumination setting screen 951 that controls the door illumination device 911 and a basket illumination setting screen 952 that controls the basket illumination device 912 may be provided. In this case, setting values such as not only the on/off but also the knock-on brightness and the time adjustment related to the second detection device 252 may be set. Furthermore, a dispenser illumination setting screen 953 that controls the dispenser illumination device 913 may be provided. In this case, setting values such as not only the on/off but also the knock-on brightness and the time adjustment related to the second detection device 252 may be set.

In addition, a scenario A setting screen 954 in which the door illumination device 911 and the basket illumination device 912 operate in an associated manner with each other, a scenario B setting screen 955 in which the door illumination device 911, the basket illumination device 912, and the dispenser illumination device 913 operate in an associated manner with each other, and a scenario C setting screen 956 in which the illumination devices operate in an associated manner with each other based on the illuminance change, etc. may be provided. Using these scenario setting screens, the operations in the associated manner with each other between the door illumination device 911, the basket illumination device 912, and the dispenser illumination device 913 according to various situations may be set.

For example, a scenario may be set in which as soon as the first detection device 251 has detected the user's approach to the refrigerator, the door illumination device 911 is configured to emit light and, subsequently, 3 seconds later, the basket illumination device 912 is configured to emit light.

In another example, a scenario may be set in which as soon as the second detection device 252 has detected the user's door knock manipulation, the door illumination device 911 is configured to emit light of a red color, and subsequently, or simultaneously, the basket illumination device 912 is configured to emit light of the red color or a complementary color to the red color.

In still another example, a scenario may be set in which as soon as the first detection device 251 has detected the user's approach to the refrigerator, the door illumination device 911, the basket illumination device 912, and the dispenser illumination device 913 are configured to emit light simultaneously.

In still yet another example, a scenario may be set in which as soon as the third detection device 253 has detected the illuminance change, the door illumination device 911 and the basket illumination device 912 are configured to emit light. In one example, when the surrounding illuminance is high, such as during the day, the surrounding around the refrigerator 1 is bright, so that both the door illumination device 911 and the basket illumination device 912 are configured to be turned on. Furthermore, when the surrounding illuminance is low, such as at night, the surrounding around the refrigerator 1 is dark, the door illumination device 911 is configured to be kept off and only the basket illumination device 912 is configured to be turned on. In this case, the inside of the refrigerator 1 may be sufficiently visible to the user.

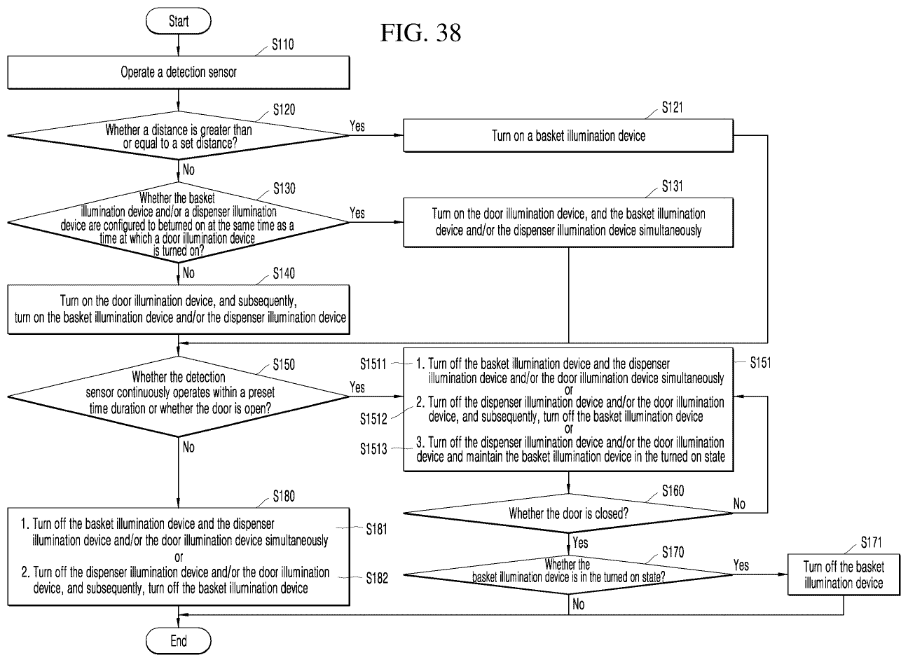

FIG. 38 illustrates a flow chart of one example scenario for controlling the light emission of various types of illumination devices.

After a start step, a step S110 in which a detection sensor of the refrigerator 1 operates may be performed. In this case, the detection sensor may be one of the first detection device 251, the second detection device 252, and the third detection device 253.

When the detection sensor operates, a step S120 in which a distance between the user and the refrigerator 1 is measured and is compared with a preset distance may be performed by the controller. When the distance between the user and the refrigerator 1 is greater than or equal to the preset distance, a step S121 in which the basket illumination device 912 is turned on may be performed. In other words, when the user is somewhat far away from the refrigerator 1, only the basket illumination device 912 may be turned on. When the distance between the user and the refrigerator 1 is smaller than the preset distance, a step S130 may be performed to determine whether the basket illumination device 912 and/or the dispenser illumination device 913 are configured to be turned on at the same time as a time at which the door illumination device 911 is turned on. That is, when the user is somewhat close to the refrigerator 1, not only the door illumination device 911 but also the basket illumination device 912 and/or the dispenser illumination device 913 may be turned on. As used herein, each of the illumination device being turned on may not only mean a state in which the brightness of each of the illumination devices is continuously maintained, but also a state in which the brightness of each of the illumination devices changes, such as dimming or flickering.

In this case, upon determination that the basket illumination device 912 and/or the dispenser illumination device 913 are configured to be turned on at the same time as a time at which the door illumination device 911 is turned on, a step S131 in which the door illumination device 911, and the basket illumination device 912 and/or the dispenser illumination device 913 are turned on simultaneously may be performed. However, upon determination that the basket illumination device 912 and/or the dispenser illumination device 913 are not configured to be turned on at the same time as a time at which the door illumination device 911 is turned on, a step S140 may be performed in which the door illumination device 911 is turned on, and, then, when a predetermined time duration has elapsed, the basket illumination device 912 and/or the dispenser illumination device 913 are turned on. In this case, whether the basket illumination device 912 and/or the dispenser illumination device 913 are configured to be turned on at the same time as a time at which the door illumination device 911 is turned on may be preset by the user on the remote device or the display unit.

After one of the steps S121, S131, and 140 is performed, a step S150 may be performed whether the detection sensor continuously operates within a preset time duration or whether the door is open is determined. In this regard, upon determination that the detection sensor continuously operates within the preset time duration or that the door is open, a step S151 may be performed. The step S151 may include various types of scenario steps such as a step S1511 in which the basket illumination device 912 and the dispenser illumination device 913 and/or the door illumination device 911 are turned off simultaneously, a step S1512 in which the dispenser illumination device 913 and/or the door illumination device 911 are turned off, and subsequently, the basket illumination device 912 is turned off, and a step S1513 in which the dispenser illumination device 913 and/or the door illumination device 911 are turned off and the basket illumination device 912 is maintained in the turned on state. When the user opens the door or stands in front of the refrigerator 1 for a long time, the dispenser illumination device 913 and the door illumination device 911 illuminating the outer portion of the refrigerator 1 may be turned off, while the basket illumination device 912 illuminating the inner portion of the refrigerator 1 may be configured to be turned off later than the dispenser illumination device 913 and the door illumination device 911 may be in the step S151. Therefore, the basket illumination device 912 may be configured to be turned off simultaneously with the turned off of the dispenser illumination device 913 and the door illumination device 911, the basket illumination device 912 may be configured to be turned off later than the dispenser illumination device 913 and the door illumination device 911 may be, or the basket illumination device 912 may be configured not to be turned off.

After the step S151, a step S160 of determining whether the door is closed may be performed. Upon determination that the door is closed, a step S170 of determining whether the basket illumination device 912 is in the turned on state may be performed. Afterwards, upon determination that the basket illumination device 912 is in the turned on state, the process proceeds to a step S171 where the basket illumination device 912 is turned off. Thus, when the basket illumination device 912 has been turned off, the process ends.

In one example, upon determination that the detection sensor does not continuously operate within the preset time duration or that the door is in the closed state, the process may proceed to a step S180. For example, the step S180 may be performed when the user approaches the refrigerator 1 and looks only at the inside thereof, or knocks on the door and looks only at the inside thereof. The step S180 may include a step S181 in which the basket illumination device 912 and the dispenser illumination device 913 and/or the door illumination device 911 are simultaneously turned off, and a step S182 in which the dispenser illumination device 913 and/or the door illumination device 911 are turned off, and subsequently, the basket illumination device 912 is turned off. In this case, the basket illumination device 912 illuminating the inner portion of the refrigerator 1 may be configured to be turned off later than the dispenser illumination device 913 and the door illumination device 911 illuminating the outer portion of the refrigerator 1 may be turned off. Therefore, the basket illumination device 912 may be configured to be turned off simultaneously with the turned off of the dispenser illumination device 913 and the door illumination device 911, or the basket illumination device 912 may be configured to be turned off later than the dispenser illumination device 913 and the door illumination device 911 may be. After the step S180 has been performed, the process may end.

What is claimed is:

1. A refrigerator comprising:
a cabinet having at least one storage chamber defined therein;
a door for opening and closing the storage chamber;
a plurality of light-source assemblies positioned in the door; and
a basket mounted on the door,
wherein each of the light-source assemblies includes:
a light source module;
a lightguide member for guiding light emitted from the light source module to the basket; and
a casing protruding toward the basket and supporting the basket.

2. The refrigerator of claim 1, wherein the light-source assemblies include a pair of light-source assemblies respectively disposed on both opposing side surfaces of the basket and configured to support lower portions of the both opposing side surfaces of the basket, respectively.

3. The refrigerator of claim 1, wherein each of the light-source assemblies is detachably fastened to the door.

4. The refrigerator of claim 1, wherein the door includes:
a main door having an opening therein, wherein the main door is pivotably connected to the cabinet; and
an auxiliary door pivotally connected to the main door to open and close the opening of the main door,
wherein the basket is mounted on the main door.

5. The refrigerator of claim 4, wherein the main door includes a door liner having the opening defined therein, and an outer plate surrounding at least one side surface of the door liner,
wherein the light-source assembly is positioned in an inner side surface of the door liner.

6. The refrigerator of claim 5, wherein a recess is defined in the inner side surface of the door liner,
wherein a portion of the light-source assembly is fixedly inserted into the recess.

7. The refrigerator of claim 1, wherein each of the light source module and the lightguide member are fixed inside the casing,
wherein the lightguide member is disposed between the light source module and an outer side surface of the basket,
wherein the light source module is positioned to horizontally overlap with one side surface of the lightguide member.

8. The refrigerator of claim 7, wherein the basket includes a lower rib protruding downwardly from a lower surface of the basket and extending along an edge of the lower surface thereof,
wherein each of the light source module and the other side surface of the lightguide member is positioned to overlap with a side surface of the lower rib in the horizontal direction.

9. The refrigerator of claim 7, wherein each of the light source module and the other side surface of the lightguide member is positioned to overlap with a lower surface of the basket in the horizontal direction.

10. The refrigerator of claim 7, wherein a vertical level of each of the light source module and the other side surface of the lightguide member is higher than a vertical level of a lower surface of the basket.

11. The refrigerator of claim 1, wherein the casing includes:
a body inserted into the door; and
a supporting protrusion protruding from the body in a frontward direction of the body,
wherein the supporting protrusion has an opening slit defined therein, wherein the opening slit is opened toward an outer side surface of the basket,
wherein a portion of a side surface of the lightguide member is exposed to the outer side surface of the basket through the opening slit.

12. The refrigerator of claim 11, wherein the opening slit is defined in a lower area of the supporting protrusion.

13. The refrigerator of claim 11, wherein the opening slit defined in the supporting protrusion includes:
a portion defined in a front surface of the supporting protrusion; and
a portion defined in one side surface of the supporting protrusion connected to the front surface of the supporting protrusion.

14. The refrigerator of claim 11, wherein a first step portion is formed on a front surface of the supporting protrusion, wherein the first step portion protrudes toward an outer side surface of the basket,
wherein the opening slit is defined in the first step portion.

15. The refrigerator of claim 1, wherein each of the light-source assemblies includes a plurality of light source modules individually controlled.

16. The refrigerator of claim 1, wherein the casing includes a body inserted into the door, and a supporting protrusion protruding from a front surface of the body in a frontward direction of the body,
wherein the body has at least one opening slit defined therein, wherein the opening slit is opened toward an outer side surface of the basket,
wherein a portion of a side surface of the lightguide member is exposed to the outer side surface of the basket through the opening slit.

17. The refrigerator of claim 1, wherein a supported portion recessed inwardly is formed on a side surface of the basket, the supported portion being configured to be engaged with the light-source assembly.

18. The refrigerator of claim 1, further comprising a detection device including at least one of:
a proximity detection device for measuring a distance from a user to the refrigerator and sensing whether the user approaches the refrigerator based on the measured distance;
a knock detection device for detecting a door knock manipulation from the user; or
an illuminance detection device for sensing whether the user approaches the refrigerator based on change in illuminance,
wherein a front surface of the door is structured such that an inside of the storage chamber is selective visible to the user through the front surface of the door,
wherein the light-source assembly is turned on or off based on a signal from the detection device when the door is in a closed state, so that the inside of the storage chamber is selectively visible to the user through the front surface of the door.

19. The refrigerator of claim 18, further comprising:
a lighting unit disposed in the storage chamber or on the door; and
a controller configured to control an on or off state of each of the light-source assembly and the lighting unit,
wherein the controller is configured to control the on or off state of the light-source assembly and the lighting unit individually or in association with each other, based on the signal of the detection device.

20. The refrigerator of claim 1, further comprising:
a lighting unit disposed in the storage chamber or on the door;
a controller configured to control an on or off state of each of the light-source assembly and the lighting unit; and
a communication unit communicating with a remote device,
wherein the controller is configured to control the on or off state of the light-source assembly and the lighting unit individually or in association with each other, based on a control signal from the remote device.
